(19) United States
(12) Patent Application Publication
(10) Pub. No.: US 2008/0140634 A1
(43) Pub. Date: Jun. 12, 2008

(54) Methods for relational searching, discovering relational information, and responding to interrogations

(76) Inventor: Frank John Williams, Los Alamitos, CA (US)

Correspondence Address: Frank John Williams, 2711 Saint Albans dr, Los Alamitos, CA, 90720, US

(21) Appl. No.: 11/998,011

(22) Filed: Nov. 27, 2007

Related U.S. Application Data
(60) Provisional application No. 60/861,169, filed on Nov. 27, 2006.

(51) Int. Cl. G06F 17/30

(52) U.S. Cl. 707/3

(57) ABSTRACT

A series of methods and systems for searching, providing, discovering, and responding to interrogation are described. In a preferred method, the querying words are replaced with identifiers, such as eeggis capable of identifying at least one of a: category information, relational information, and respective information, thus allowing the search engine to respond through Thinking Process Algorithms (TPA) the corresponding interrogations while incorporating self discovery, learning, and deductive search and findings. In one embodiment, mathematical analysis of responses is clustered into different type of answer while also suggesting the correct response.

### RELATED APPLICATIONS

This patent application claims the benefit of U.S. provisional patent application Ser. No. 60/861,169 filed 2006 Nov. 27 by the present inventor

### BACKGROUND

1. Field of the Invention

The present invention relates generally to a method for searching, retrieving and providing information in general. More particularly, to a method for searching, discovering, and answering to interrogational queries.

2. Description of Related Art

The search engine is one the most important and valuable tools the Internet offers to its users, allowing them to quickly find important and relevant information. However, search technology aims for the retrieval of matching information rather than mining the information and responding to the user's query. In such fashion, users are forced to choose and implemented specific words in order to retrieve the desired information. For example, a user trying to find the date of Napoleon's death, will enter a query such as “death of Napoleon” hoping that records containing said words also contain the time information. Consequentially, hundreds if not thousands or records are retrieved, many comprising other forms of information not specific to the inquiring data such as records describing how Napoleon died and/or where Napoleon died versus the time and/or month of death; which can quickly overwhelm, confuse and discourage the user by retrieving additional and conceptually extraneous information. Although current and envisioned technologies such as Artificial Intelligence intend to address such informational diversity, the systems are unfortunately still in infancy, requiring large amount of research, programming, equipment and skill; while nonetheless they still fail to distinguish and/or group results based on concept when multi-conceptual words are involved and lack the ability to handle directional conceptuality.

### SUMMARY OF THE INVENTION

The present invention teaches certain benefits in use and construction which give rise to the objectives and advantages described below. The methods embodied by the present invention overcome the limitations and shortcomings encountered when searching and retrieving particular information, permitting the user to enter specific questions or interrogations to find responses while avoiding irrelevant information capable of confusing the user and obscuring results.

### OBJECTS AND ADVANTAGES

A primary objective inherent in the above described method of use is to provide a means and methods for a user to ask a question for retrieving specific information that answers the said question by means not taught by the prior arts and further advantages and objectives not taught by the prior art. Accordingly, several objects and advantages of the invention are

Another objective is to reduce irrelevance.

Another objective is to enhance intuitive use for search engines.

Another objective is to enhance ecommerce.

Another objective is to find information regardless of the user's searching skills.

A further objective is to retrieve information regardless of synonym being used.

A further objective is to allow superior searching accuracy.

A further objective is to reduce the time a user spends retrieving information.

A further objective is to respond to interrogations.

A further objective is to find and discover information that is only otherwise available through rational and deductive thought.

Other features and advantages of the described methods of use will become apparent from the following more detailed description, taken in conjunction with the accompanying drawings, which illustrate, by way of example, the principles of the presently described methods and their methods of use.

### BRIEF DESCRIPTION OF THE DRAWINGS

The accompanying drawings illustrate at least one of the best mode embodiments of the present method of use. In such drawings:

FIG. 1 is a non-limiting exemplary illustration of a single identifier such as an “engineered encyclopedic global grammatical identity” (eeggi) comprising several forms and types of information;

FIG. 2 is a non-limiting illustration of some exemplary and significant steps of the inventive method implementing eeggi methodology for responding to a “where” type interrogation;

FIG. 3A and FIG. 3B are a non-limiting illustrations of some exemplary and significant steps of the inventive method implementing eeggi for responding to a “who” interrogation and other variations implementing several queries;

FIGS. 4A and 4B are non-limiting illustrations of some exemplary and significant steps of other variations of the inventive method implementing an Answering Button for responding to a “when” interrogation while still implementing eeggi;

FIG. 5 is a non-limiting exemplary diagram of a further variation of the inventive method depicted in FIG. 4A and FIG. 4B;

FIG. 6A, FIG. 6B, FIG. 6C, and FIG. 6D are non-limiting exemplary illustrations of other variations of the inventive method responding to several “which” interrogations;

FIG. 7A, FIG. 7B, FIG. 7C, and FIG. 7D are non-limiting exemplary illustrations of other variations of the inventive method responding to “what” interrogations while implementing additional internal queries for discovering an answer and/or assuming an answer;

FIG. 8A and FIG. 8B are non-limiting exemplary illustrations of another variation of the inventive method identifying and/or becoming suspicious and/or assigning the species (BI) information of an unidentified word and/or new eeggi;

FIG. 9A and FIG. 9B are non-limiting exemplary illustrations of a further variation of the inventive method compiling several equal responses into a single cluster response, and compiling several different responses into several cluster responses while optionally utilizing statistical analysis and calculations to identify said clusters;

FIG. 10A and FIG. 10B are non-limiting exemplary illustrations of a further variation of the inventive method answering to affirmative and negative interrogations;

FIG. 11 is a non-limiting exemplary illustration of the inventive method dealing with a “how much” interrogation;

FIG. 12 is a non-limiting exemplary illustration of another variation of the inventive method dealing with compound eeggis and affirmative/negative type interrogations.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications of what is described herein without departing from its spirit and scope. Therefore, it must be understood that what is illustrated is set forth only for the purposes of example and that it should not be taken as a limitation in the scope of the present system and method of use. In addition, all of the above mentioned figures work in conjunction showing in part, novel combinations of steps for disclosing the inventive method in a preferred yet not limiting mode.

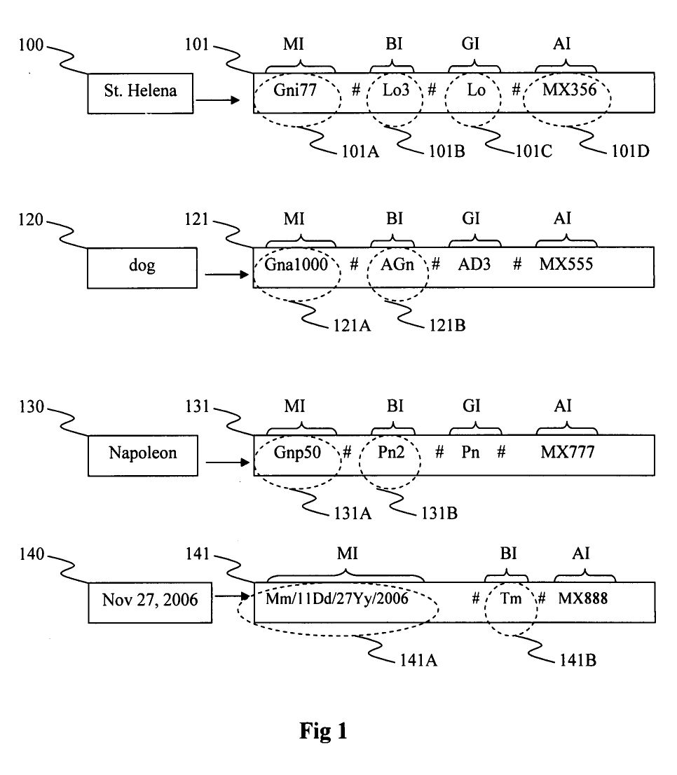

FIG. 1 is a non-limiting illustration of a concept metric identifier such as an “engineered encyclopedic global grammatical identity” or “eeggi” for short, containing several forms of eeggis, each comprising multiple types of internal information used for identifying at least one of a: specific content, associations, and programming information. The First Word 100 (FIG. 1) is identified by the corresponding First eeggi 101 (FIG. 1). As illustrated, the First eeggi contains several forms and/or groups of internal information, such as the Main Identifying Information 101A (FIG. 1) or “MI” for identifying the eeggi itself, the Basic Species or Sub-category Information 101B (FIG. 1) or “BI” for identifying its immediate category and/or type of information, the Generic Species or Category Information 101C (FIG. 1) or “GI” for identifying the general category of the eeggi, and finally the Associative Identifying Information 101D (FIG. 1) or “AI” for identifying additional remote information not immediately present or contained by the eeggi itself, as illustrated in the figure; wherein the “#” symbol helps this disclosure visualize the separation of the internal information of each eeggi. In such fashion, the several internal information within each eeggi specify and/or identify particular classes and/or types of information that the discovery engine will further use to search, manipulate, classify, and/or even respond to interrogations in a query. For example, on the First eeggi 101 (FIG. 1), the BI 101B (FIG. 1) or “Lo” identifies that the eeggi (and/or its respective word “St. Helena”) is a world location or geographical class information (Lo is used to describe places or locations on earth). In similar fashion, the Second Word 120 (FIG. 1) “dog” is identified by the Second eeggi 121 (FIG. 1) which comprises several types of information, such as the BI 121B (FIG. 1) or “AGn” which is used to identify that “dog” (or the eeggi) is an animal, while the “Gna” portion of the MI 121A (FIG. 1) or “Gna1000” describes the eeggi as a group noun or general noun describing an organism in general. The Third Word 130 (FIG. 1) or “Napoleon” is identified by its respective Third eeggi 131 (FIG. 1) comprising its MI 131B (FIG. 1) for identifying a personal noun of a specific male human or group of humans. Finally, the Fourth Word 140 (FIG. 1) or “Nov. 27, 2006” identified by its Fourth eeggi 141 (FIG. 1) comprising its MI 141A (FIG. 1), its BI 141B (FIG. 1) and others. Please note, how one or several information within the eeggi can combine efforts to identify particular amounts, types and/or class of information, categories, sub-categories, and even further associations soon to be depicted. Noteworthy, although eeggi search methodology, through its MI and/or others has the ability to identify a single concept (single value), a group of synonyms (value spectrum), group of similarities (greater value spectrum), etc. the present and preceding figures and examples make use of a single value or identifier in an effort to keep the images and illustrations simple and comprehensible. In such fashion, it must be understood, that other technologies and methodologies such as group identifiers (one identifier represents all synonyms of a word) and others can equally implement and make use of the disclosed inventive method.

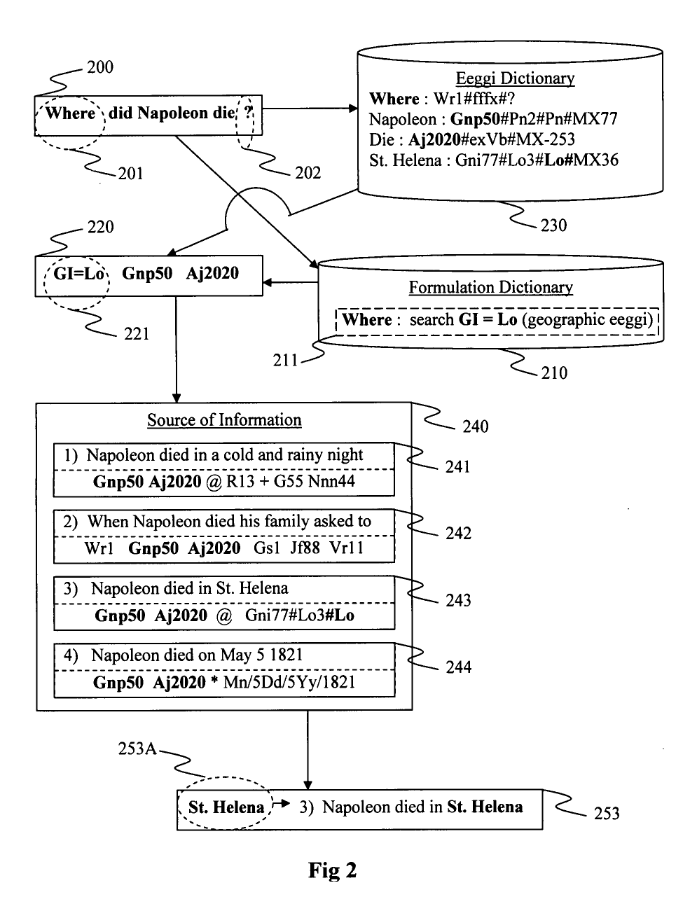

FIG. 2 is a non-limiting illustration of some exemplary and significant steps of the inventive method implementing eeggi for responding to a “where” type query or answering to a “where” interrogational element (IE). Conceptually speaking, “where” is specifically a demand or request for “location” type information. In fact, it is referring to the general retrieval of, categorically speaking, geographical data; which is what inherently the GI information of the eeggi is in charge of identifying. Accordingly, “where” interrogations will deal directly with the GI (or other location information) of the eeggis. For example, the Initial Query (IQ) 200 (FIG. 2) asking the question “Where did Napoleon die?” has at the end of the query the “?” symbol 202 (FIG. 2) which in this particular example is used to identify or differentiate an interrogation. In such fashion, the discovery engine prepares to implement the Formulation Dictionary 210 (FIG. 2) containing the “where” formulation or the “Where Thinking Process Algorithm” (WRTPA) 211 (FIG. 2), and any eeggi internal information such as the “Generic Species or Category Information (GI) for answering the interrogation, if possible. Accordingly, the “where” IE 201 (FIG. 2) and the “?” 202 (FIG. 2) symbol, both identified the need for the WRTPA 211 (FIG. 2) in the Formulation Dictionary 210 (FIG. 2) which defines a search for a “GI=Lo” to be retrieved. As a consequence, the IQ 200 (FIG. 2) is converted and/or replaced with the Formulation Eeggi Query 220 (FIG. 2) or FEQ for short, involving the searcher for a GI=Lo eeggi and of course, the other eeggis of the query (Gnp50 and Aj2020). For the practical purpose of illustrating this disclosure, the GI of the searched or record eeggis (eeggis in the Source or Information (SOI)) will be referred as GI_{R}; wherein “R” obviously refers to “record.” In such fashion, the FEQ 220 (FIG. 2) or “GI=Lo, Gnp50, Aj2020” searches the SOI 240 (FIG. 2). Please note, although the word “where” is present in the Eeggi Dictionary 230 (FIG. 2), it is the Formulation Dictionary's information (GI=Lo) that is used because of the “?” symbol. In the SOI 240 (FIG. 2) there are four exemplary records or websites each describing their content in text and eeggi version (the eeggi version is immediately below each text version). As illustrated, the First Record 241 (FIG. 2) contains only two matching eeggi (Gnp50 and Aj2020) and yet no geographical (GI=Lo) eeggi in its immediate neighborhood or surrounding area. Therefore, the First Record is not retrieved. In similar fashion, the Second Record 242 (FIG. 2) and the Fourth Record 242 (FIG. 2) do not contain sufficient information (matches) and therefore are not retrieved either. However, the Third Record 243 (FIG. 2) has all the eeggis, including a geographical type eeggi (GI=Lo). Consequentially, the Third Record is retrieved and displayed in the Response Display 253 (FIG. 2). Please note, not only the matching record is retrieved; but also a response 253A (FIG. 2) is generated; which in this case involved repeating the information (text) corresponding to the geographical eeggi that was found due to the “where” IE.

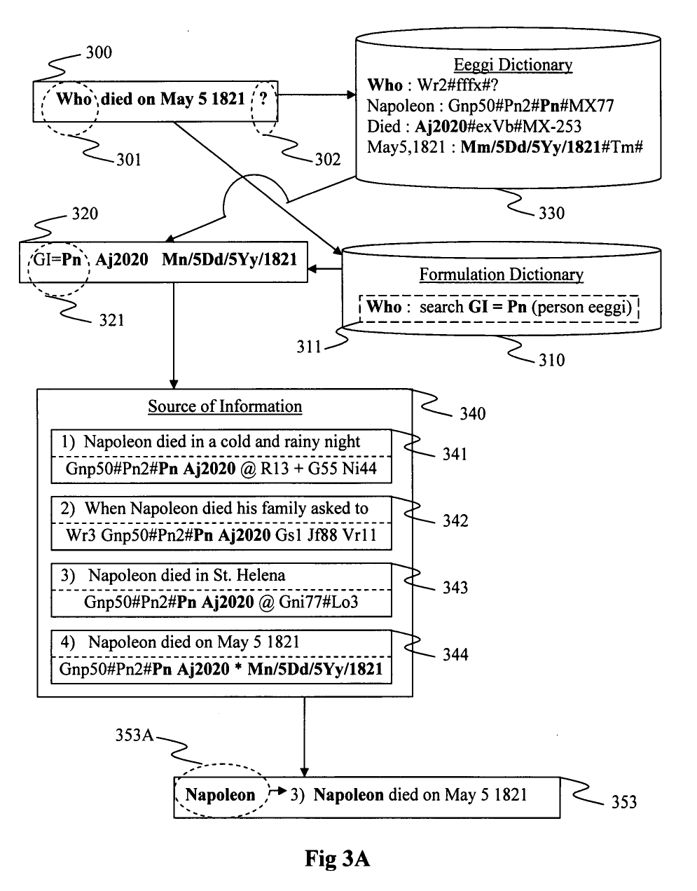

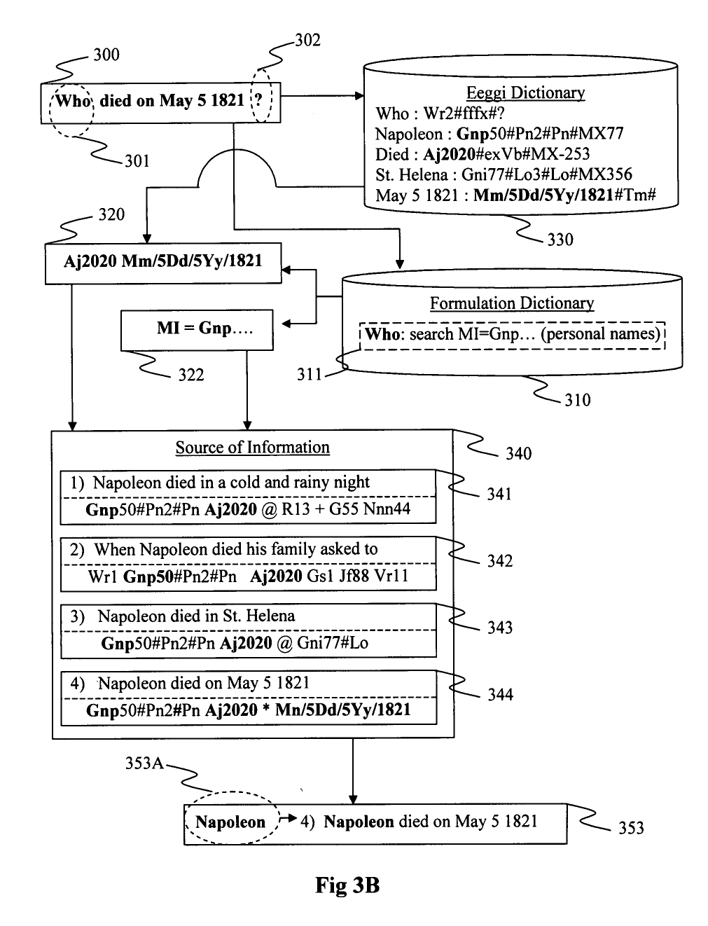

FIG. 3A and FIG. 3B are a non-limiting illustrations of some exemplary and significant steps of the inventive method implementing eeggi for responding to a “who” interrogation element (IE) and another variations implementing several queries. With conceptual similarity to “where” the “who” IE specifically demands a “person” type information or eeggi. Accordingly, “who” interrogations deal directly with GI=Pn and/or others; wherein “Pn” is the human category identifier. For example, the initial query (IQ) 300 (FIG. 3A) asks “Who died on May 5, 1821?”. Because of the “?” symbol 302 (FIG. 3A) and the “who” IE 301 (FIG. 3A), the discovery engine prepares to implement the Formulation Dictionary 310 (FIG. 3A) containing the “who” formulation or the “Who Thinking Process Algorithm” (WOTPA) 311 (FIG. 3A). As a consequence, the IQ 300 (FIG. 3A) is converted and/or replaced with the Formulation Eeggi Query 320 (FIG. 3A) or FEQ for short, involving the search for a record eeggi which its GI=Pn (GI_{R}=Pn), and the other eeggis (Aj2020 and Mn/5Dd/5Yy/1821). In such fashion, the FEQ 320 (FIG. 3A) or “GI_{R}=Pn, Aj2020, Mn/5Dd/5Yy/1821” searches the Source of Information 340 (FIG. 3A) or SOI for short. Please note, although “who” is in the Eeggi Dictionary 330 (FIG. 3A), it is the WOTPA 311 (FIG. 3A) that is used because of the “?” 302 (FIG. 3A) symbol and the “who” IE 301 (FIG. 3A). As illustrated, the SOI 340 (FIG. 3A) has four exemplary records or websites each describing their content in text and eeggi version (the eeggi version is immediately below each text version). As illustrated, the First Record 241 (FIG. 2) contains only two matching eeggi (GI=Pn and Aj2020) and yet no Mn/5Dd/5Yy/1821, therefore is not retrieved. In similar fashion, the Second Record 342 (FIG. 3A) and the Third Record 343 (FIG. 3A) do not contain sufficient matches, and therefore are also ignored. However, the Fourth Record 344 (FIG. 3A) has all the eeggis, including the GI_{R}=PN eeggi. Consequentially, the Fourth Record is retrieved and displayed in the Response Display 353 (FIG. 3A). Please note, not only the matching record is retrieved; but also a response 353A (FIG. 3A) is generated; by repeating the text information corresponding to the GI_{R}=Pn or person eeggi. FIG. 3B is another non-limiting exemplary illustration of the inventive method this time dealing with multiple internal information fields such as the GI and the BI in conjunction, and also multiple queries thus exemplifying that there are several ways and methods to implement different types of queries, formulations and their respective internal types of information and content. For example, the IQ 300 (FIG. 3B) is requesting an answer to “Who died on May 5, 1821 ?” In contrast to the formulation of FIG. 3A, the WOTPA 311 (FIG. 3B) of the present figure requires that the MI start with “Gnp.” In addition, the discovery engine in this example separates the formulation data from the other eeggis in the IQ. Accordingly, the IQ 300 (FIG. 3B) is divided and converted into two eeggi queries such as the Normal Eeggi Query 320 (FIG. 3B) or NEQ involving “Aj2020 and Mn5/Dd/5Yy/1821” and the FEQ 322 (FIG. 3B) or “MI=Gnp . . . ” each comprising information from the Eeggi Dictionary 330 (FIG. 3B) and the Formulation Dictionary 310 (FIG. 3B) respectively. As illustrated, the SOI 340 (FIG. 3B) contains four exemplary records describing their content in text and eeggi version (the eeggi version is below each text version); wherein the First Record 341 (FIG. 3) contains incomplete matches to both queries. That is, full matching the FEQ 322 (FIG. 3B) but partially matching the NEQ 320 (FIG. 3B), thus ignoring the said First Record 341 (FIG. 3B). In similar fashion, the Second Record 342 (FIG. 3B) and the Third Record 343 (FIG. 3) contain insufficient matching data to both queries (FEQ and NEQ), therefore are not retrieved. However, the Fourth Record 344 (FIG. 3B) has all the eeggis of the NEQ 320 (FIG. 3B) and the FEQ 322 (FIG. 3B). Consequentially, the Fourth Record is retrieved and displayed in the Response Display 353 (FIG. 3B). Please note, not only the matching record is retrieved; but once again, a Response 353A (FIG. 3B) or “Napoleon” is generated; by repeating the text of the Gnp50 eeggi found thanks to the “who” IE.

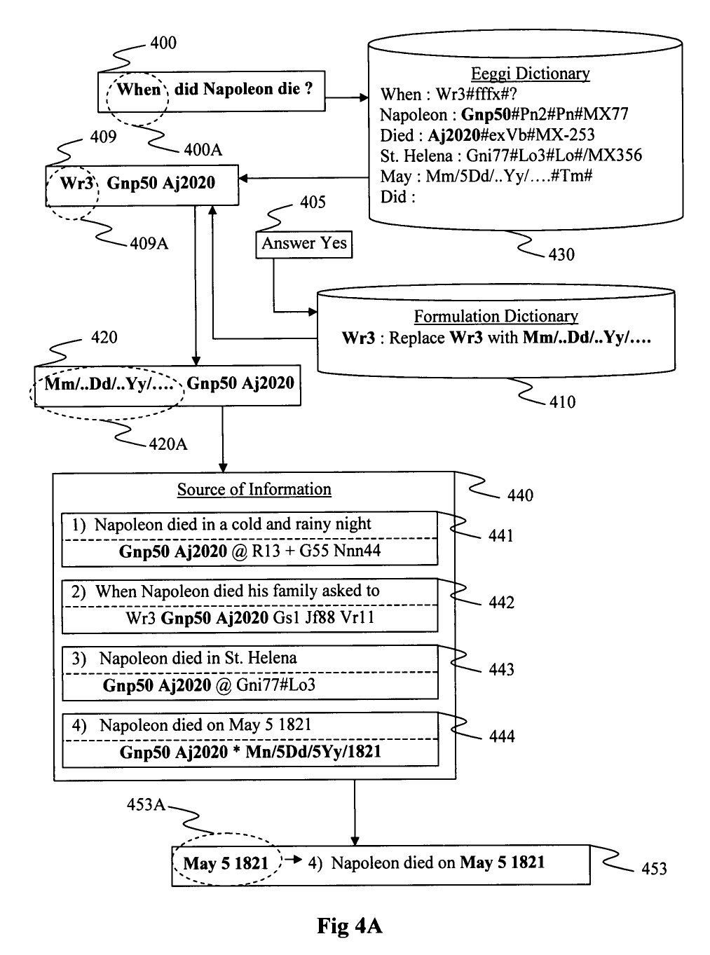

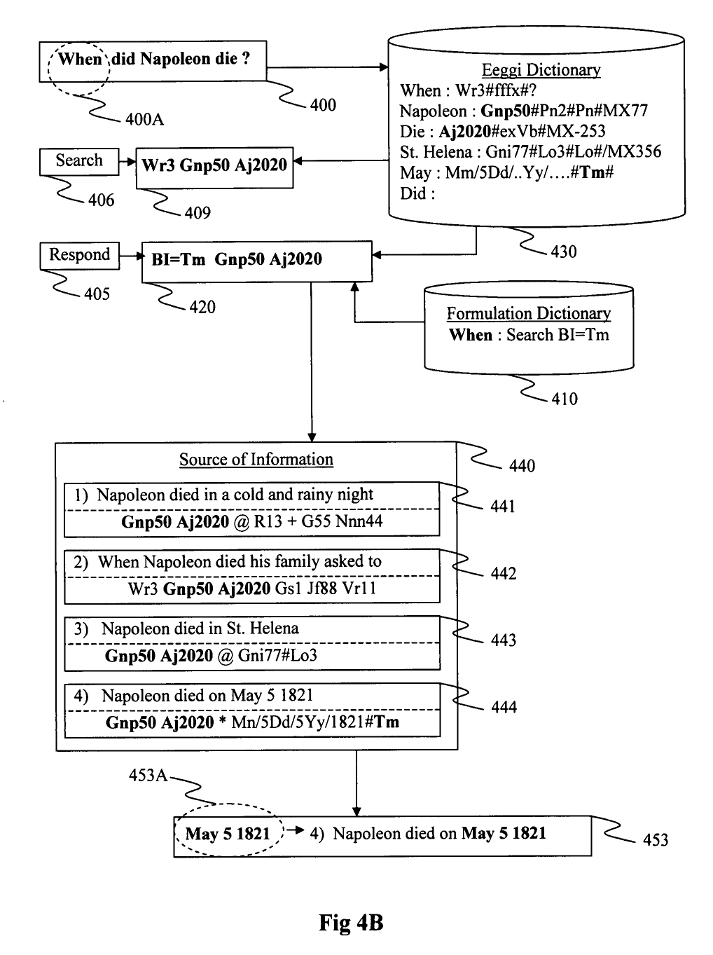

FIG. 4A and FIG. 4B are non-limiting illustrations of some exemplary and significant steps of other variations of the inventive method this time implementing an Answering Button, for responding to “when” interrogation elements (IE) while still utilizing eeggi(s). Clicking the Answer Button 405 (FIG. 4A) turns the Answering ability of the discovery engine “on” or “off.” For example, if the answering function is “on,” then the Answer Button 405 (FIG. 4A) displays the word “Yes” as illustrated. However, if the answering function is “turned off” then the Answer Button will display “No.” In this example, the Answer function is “on” therefore the Answer Button 405 (FIG. 4A) displays the “Yes” characters. Accordingly, the IQ 400 (FIG. 4A) is converted using the Eeggi Dictionary 430 (FIG. 4A) into the NEQ 409 (FIG. 4A). Please note, the query is named NEQ (Normal Eeggi Query) because there is no formulation implicated. For example, “When” 400A (FIG. 4A) simply becomes “Wr3” 409A (FIG. 4A). But because of the Answer Function (Answer Button is “Yes”), the Formulation Dictionary 410 (FIG. 4A) is searched providing the information to “replace” the just converted “Wr3” eeggi with the “Mm/ . . . Dd/ . . . Yy/ . . . ” 420A (FIG. 4A) form eeggi (and/or #Time# eeggi). In such fashion, the NEQ 409 (FIG. 4A) is “formulated” (converted, etc.) into the FEQ 420 (FIG. 4A) comprising the three eeggi (Mm/ . . . Dd/ . . . Yy/ . . . , Gnp50, and Aj2020), which searches the SOI 440 (FIG. 4A). As illustrated, the SOI contains four exemplary records. The First Record 441 (FIG. 4A) has only two of the three eeggi; therefore is not retrieved. The Second Record 442 (FIG. 4A) has all the eeggis of the NEQ 409 (FIG. 4A); but unfortunately the NEQ was replaced with the FEQ 420 (FIG. 4A); therefore is not retrieved either. Please note, if the Answer Button was “off” (Answer function not active) the discovery engine would have retrieved the Second Record. The Third Record 443 (FIG. 4A) also fails to offer sufficient matches, thus is not retrieved. However, the Fourth Record 444 (FIG. 4A) has sufficient matches (Gnp50, Aj2020, and Mn/ . . . Dd/ . . . Yy/ . . . type eeggi), thus is retrieved as shown by the Response Display 453 (FIG. 4A), wherein in similar fashion to previous figures, the discovery engine “answer” the query by repeating and/or highlighting the text version of the date eeggi. Please note, how in this example the Mn/ . . . Dd/ . . . Yy/ . . . formatting eeggi is used instead of its BI=Tm, in an effort to illustrated that several searching and/or selecting and/or formulating methods can be used without departing from the main scope and spirit of the idea. FIG. 4B is another non-limiting exemplary illustration of the inventive method of FIG. 4A this time identifying the entry of an IE such as “when” for automatically displaying a Response Button while implementing the BI of the time eeggi. The instant that an IE, such as “when” 400A (FIG. 4B) is entered/identified in the IQ Field 400 (FIG. 4B) the Response Button 405 (FIG. 4) is displayed or appears in this example next to the Standard Search Button 406 (FIG. 4B). Please note, while the Standard Search Button generates the NEQ 409 (FIG. 4B) involving the corresponding eeggis to the words in the IQ 400 (FIG. 4B), the Response Button 405 (FIG. 4B) is responsible for generating the FEQ 420 (FIG. 4B) resulting from the Eeggi Dictionary 430 (FIG. 4B) in conjunction with the Formulation Dictionary 410 (FIG. 4B). Please note how in this example, the “when” formulation involves the “BI” information of the eeggi; wherein said BI equals “Tm.” In addition, also in this example, after entering the IQ 400 (FIG. 4B), the just appeared Response Button 405 (FIG. 4B) is clicked, thus enabling the Response ability. Accordingly, the IQ 400 (FIG. 4B) is converted using the Eeggi Dictionary 430 (FIG. 4B) into the FEQ 420 (FIG. 4B) comprising the three eeggi (BI=Tm, Gnp50, and Aj2020), which searches the SOI 440 (FIG. 4B). As illustrated, the SOI contains four exemplary records, such as the First Record 441 (FIG. 4B), the Second Record 442 (FIG. 4B), and the Third Record 443 (FIG. 4B) which they all fail to have sufficient matches, therefore are not retrieved. However, the Fourth Record 444 (FIG. 4B) has sufficient matches (Gnp50, Aj2020, and BI=Tm), therefore is retrieved as shown by the Response Display 453 (FIG. 4B) displaying the response May 5, 1821 453A (FIG. 4B).

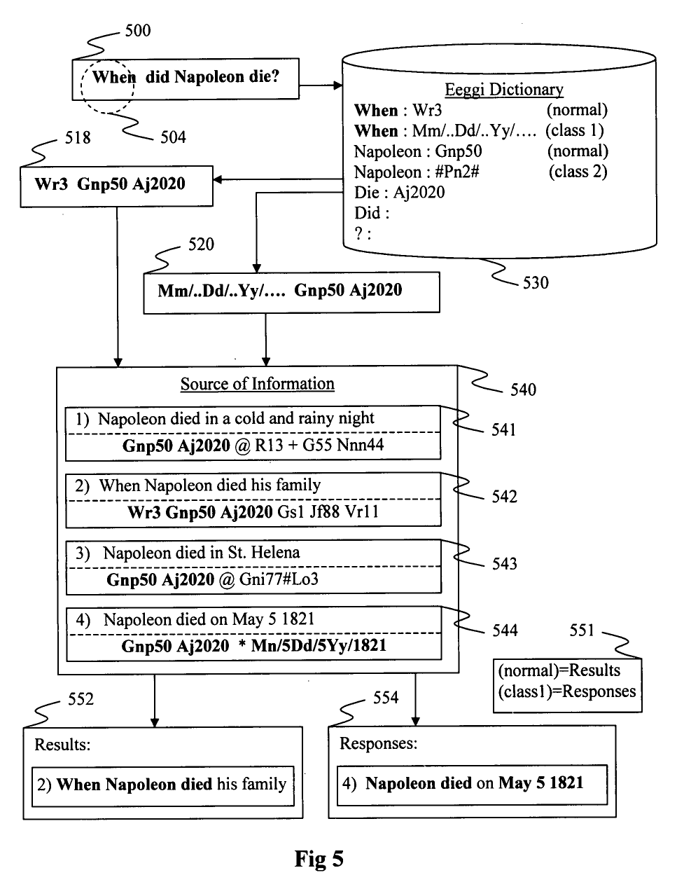

FIG. 5 is a non-limiting exemplary illustration of a further variation of the inventive method depicted in the FIG. 4A, FIG. 4B, and others. In this example, there is no activation of an answering function, yet the system can still respond to interrogations while grouping the answers. The IQ 500 (FIG. 5) comprising the word “when” 504 (FIG. 5) is converted implementing the Eeggi Dictionary 530 (FIG. 5); which contains two different eeggi identifying the word “when”. Consequentially, two separated queries are executed. The NEQ 518 (FIG. 5) or “Wr3, Gnp50, Aj2020” that simply searches for the Wr3 eeggi, and the FEQ 520 (FIG. 5) or “Mm/ . . . Dd/ . . . Yy/ . . . , Gnp50, Aj2020” that searches for time eeggis. Please note, how in the Eeggi Dictionary 530 (FIG. 5) the “Mm/ . . . Dd/ . . . Yy/ . . . ” eeggi is classified as a “(class 1)” while the “Wr3” eeggi is classified as a “(normal)” eeggi. In such fashion, “class” eeggis are used to answer queries, while “normal” eeggis are simply used to search information. Accordingly, the two different eeggis (normal and class1) are responsible for two different and separate searches which are optionally tabbed and/or titled as described by the Ruling Statement 551 (FIG. 5). In such fashion, the First Response Display 552 (FIG. 5) depicts the results from the NEQ 518 (FIG. 5) or “Wr3, Gnp50, Aj2020” (records wherein “when” is a normal eeggi), and the Second Response Display 554 (FIG. 5) depicts the result from the FEQ 520 (FIG. 5) or “Mn/ . . . Dd/ . . . Yy/ . . . , Gnp50, Aj2020” (class type eeggis). Noteworthy, when a “class 1” eeggi such as when, where, who, etc. is present in a query, the search and retrieval also involves “class 2” eeggis, thus allowing the search or discovery engine to separate results for responses (IE present), and for standard searches. In addition, in this basic example, the word “did” and symbol “?” in the Eeggi Dictionary 530 (FIG. 5) do not have any identified eeggi, thus are remove from queries. However, further interpretation of said and other secondary grammatical elements such as: did, on, in, at, the, etc. can be taken into consideration for identifying other eeggis and/or information within the eeggis and/or relationships between eeggis, to further enhance and/or distil results based on the characteristics of a given language (for example, in Spanish “did” does not exist).

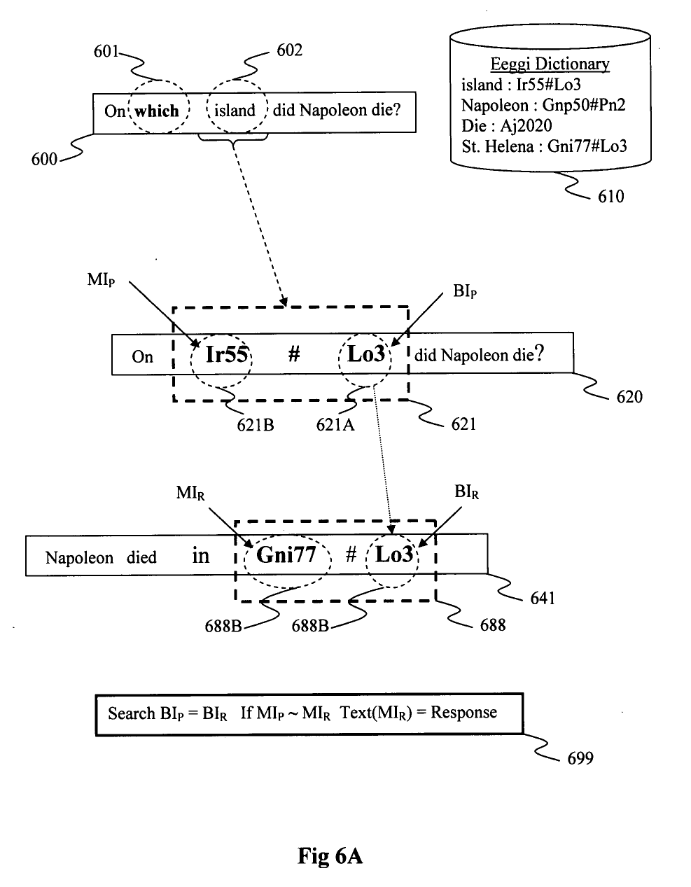

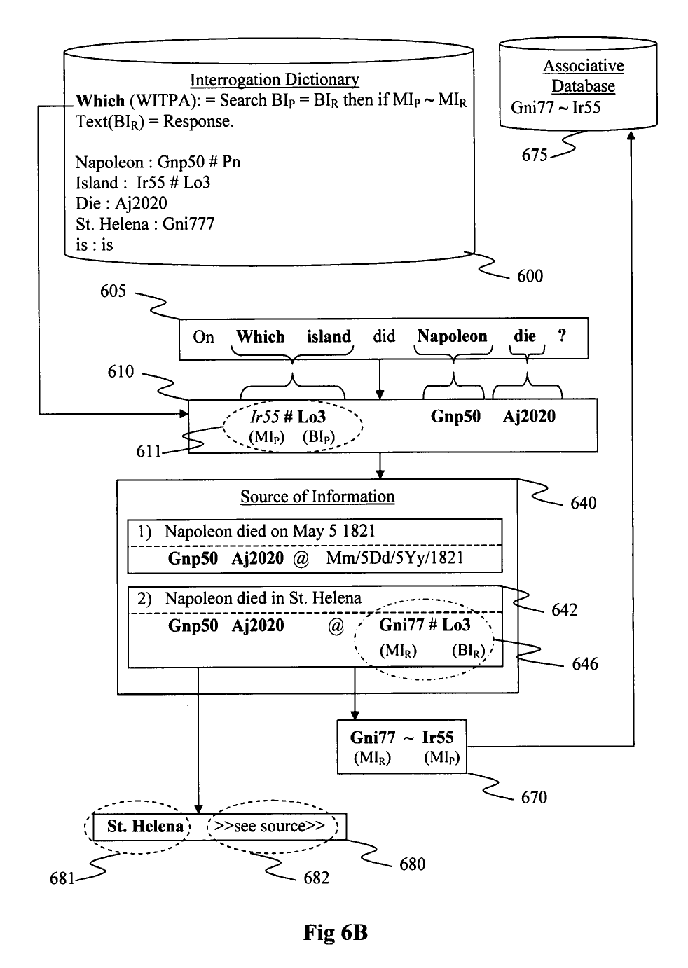

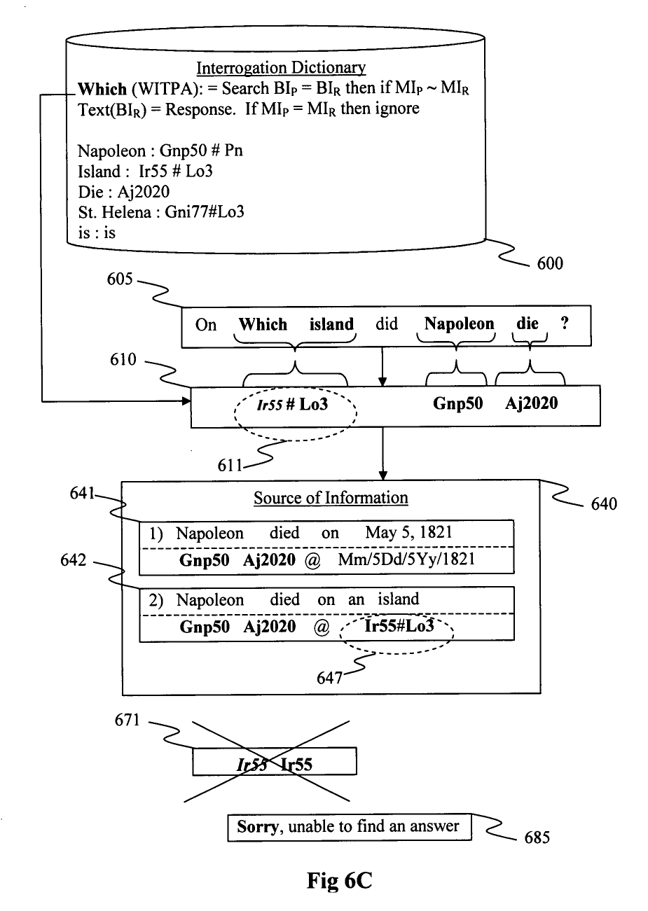

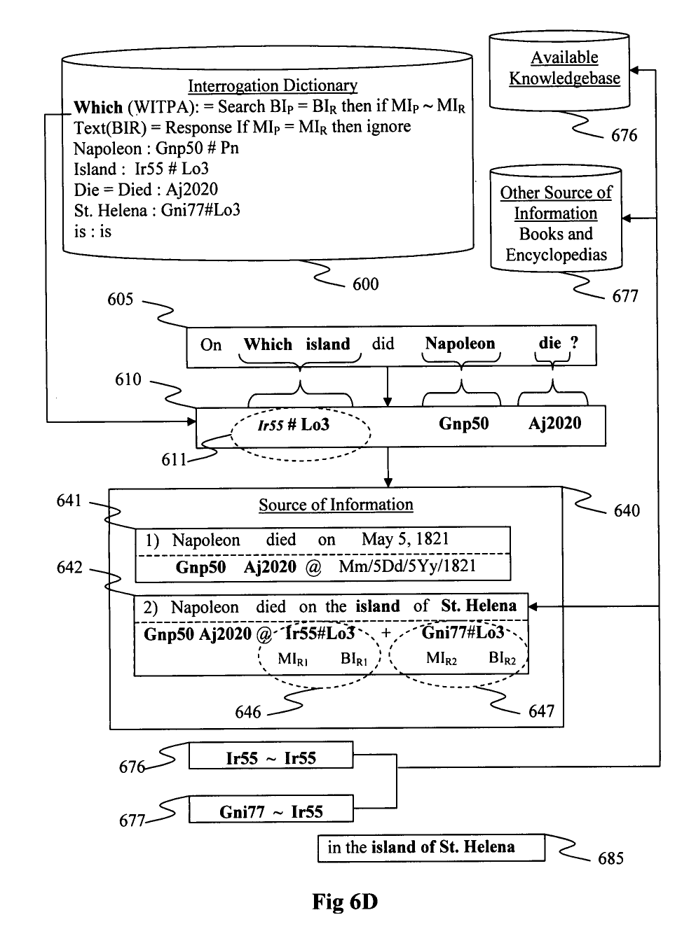

FIG. 6A, FIG. 6B, FIG. 6C, and FIG. 6D are non-limiting exemplary illustrations of other variations of the inventive method for responding to several interrogations involving the “which” IE, and optional Associative Databases, such as conclusive, deductive, relational content, suggestive database, etc. In contrast to “when,” “where,” and “who,” that inherently identify the type of information desired the “which” IE (in English) uses the word in its proximity (proximal word) for identifying the type of information desired or required. For example, “which island” is requesting an island or location, while “which car” is requiring an apparatus. In such fashion the proximal words (island and car) and/or the respective “proximal eeggi” (eeggi replacing the proximal word) inquire information regarding their inherent categories. Furthermore, although as previously illustrated; wherein the disclosed inventive method uses several of the exemplary internal data (MI, BI, GI, etc.) in whole, combinations or partially to generate the responses, the proceeding illustrations will implement the said internal data in a particular fashion and purpose, thus facilitating and simplifying the present disclosure. FIG. 6A is a non-limiting illustration depicting the basic steps involved with the Proximal eeggi, and the basic terminology that will be used in the proceeding exemplary illustrations, in addition to introducing the “which” formulation or WITPA for short. The IQ 600 (FIG. 6A) contains the “which” IE 601 (FIG. 6A), and to its right is the “Proximal word” 602 (FIG. 6A) or “island” which are converted into the eeggi query or corpus 620 (FIG. 6A). As illustrated, the Proximal eeggi 621 (FIG. 6A) is “Ir55#Lo3” wherein “Ir55” 621B (FIG. 6A) is the MI of the Proximal eeggi or MI_{P}, and “Lo3” 621A (FIG. 6A) is the Proximal eeggi's BI or BI_{P}. In similar fashion, the eeggi parts on the records are comparably identified. For example, in the Record 641 (FIG. 6A), the location eeggi 688 (FIG. 6A) or “Gni77#Lo3” has a MI_{R}=Gni77 688B (FIG. 6A), and a BI_{R}=Lo3 688A (FIG. 6A). Also illustrated in FIG. 6A the WITPA 699 (FIG. 6A) which has two commands or requirements, such as the first command (Search BI_{P}=BI_{R}) responsible for generating the FEQB queries (formulation eeggi query of the BI information), and the second command (If MI_{P}˜MI_{R}; then text of MI_{R} is the response) responsible for generating the FEQM queries (formulation eeggi query of the MI information). In other words, WITPA (“which” formulation) implies a first query or FEQB finding if the BI_{P} equals the BI_{R} and a second query or FEQM finding if the MI_{P} and MI_{R} relate. If the MI_{P} and MI_{R} relate the text of the MI_{R} is the response. FIG. 6B is a non-limiting exemplary illustration of a WITPA operation or response function. The Interrogation Dictionary 600 (FIG. 6B) describes the main WITPA. Accordingly, the IQ 605 (FIG. 6B) is converted into the FEQB 610 (FIG. 6B) or “BI=Lo3, Gnp50, Aj2020” implementing the Interrogation Dictionary 600 (FIG. 6B). Noteworthy, to facilitate this illustration, the Proximal eeggi 611 (FIG. 6B) is displayed in its entirety, but only the BI_{P} (Lo3) is used for the FEQB. As illustrated, the SOI 640 (FIG. 6B) has two records. The First Record 641 (FIG. 6A) doesn't have sufficient matches (Mm/Dd/Yyyy eeggi instead of a “Lo3” eeggi). However, the Second Record 642 (FIG. 6B) has all matching eeggis including BI_{P}=BI_{R}=Lo3. The WITPA next step is to find if the MI_{P} relates to the MI_{R} which is carried out by the FEQM. The FEQM (MI_{P}˜MI_{R}) 670 (FIG. 6B) is generated and searches the Associative Database 675 (FIG. 6B), discovering that Gni77 relates to IR55. As a result, the text version of the MI_{R} or “St. Helena” 681 (FIG. 6B) is displayed in the Response Display 680 (FIG. 6B). In addition, the “See Source” link 682 (FIG. 6B) allows the user to view the record or records responsible for generating said response. FIG. 6C is another non-limiting exemplary illustration of the inventive method this time unable to respond to the interrogation. The IQ 605 (FIG. 6C) is converted into the FEQB 610 (FIG. 6C) implementing the Interrogation Dictionary 600 (FIG. 6C) and the WITPA. Noteworthy, once again, to facilitate the illustration, the Proximal eeggi 611 (FIG. 6C) is displayed entirely, but only BI_{P}=Lo3 is used in the FEQB. As illustrated, the SOI 640 (FIG. 6C) has two records; wherein the First Record 641 (FIG. 6C) lacks a location (Lo3) eeggi, therefore is ignored. However, the Second Record 642 (FIG. 6C) has all matching eeggis (Gnp50, Aj2020 and BI_{R}=Lo3). As a result, FEQM 671 (FIG. 6C) is formed (MI_{P} relates to MI_{R}). However, as illustrated MI_{P}=MI_{R} (same eeggi), thus ignoring the results and disabling the discovery engine of finding a relationship. Consequentially, the Sorry No Answer 685 (FIG. 6C) is generated. Please note, the IQ, FEQB, FEQM, etc. can be registered for further attempts for generating a response after new entries, human inputs, new sources of information, programs, etc. FIG. 6D is another non-limiting exemplary illustration of the inventive method responding to another “which” interrogation. The Interrogation Dictionary 600 (FIG. 6D) and the WITPA modify or convert the IQ 605 (FIG. 6D) into the FEQB 610 (FIG. 6D) or “BI_{P}=Lo3, Gnp50, Aj2020.” Noteworthy, once again, to facilitate this illustration, the Proximal eeggi 611 (FIG. 6D) is displayed in its entirety, but only the BI is involved in the FEQB 610 (FIG. 6D). As illustrated, the SOI 640 (FIG. 6D) has two records. The First Record 641 (FIG. 6D) has a date eeggi (May 5, 1821) but not a “Lo3,” therefore is ignored. However, the Second Record 642 (FIG. 6D) has excess eeggis such as the First eeggi 646 (FIG. 6D) and the Second eeggi 647 FIG. 6D). As a result, two FEQM are launched for every BI=Lo3 eeggi. The First FEQM 676 (FIG. 6D) involves the MI_{P1}=MI_{R1} therefore is not implemented. However, the Second FEQM 677 (FIG. 6D) or MI_{P2} MI_{R2} (Ir55˜Gn177) is searched in the Available Knowledgebase 676 (FIG. 6D) which provides no relations, and in the Other Source of information 677 (FIG. 6D) which also fails to provide any relationships. However, continuing the search in the SOI, it is the very same Second Record 642 (FIG. 6D) which successfully associates the two MI (Gni77˜Ir55). As a result, the text of MI_{R2} is display in the Response Display 685 (FIG. 6D); but this time the answer involved the removal of the Gnp50 (Napoleon) and Aj2020 (die) eeggis not involved in the WITPA. Please note, the First eeggi 676 (FIG. 6D) and the Second eeggi 677 (FIG. 6D) relate through a “+” eeggi which indeed is used for associating location eeggis (island OF St. Helena).

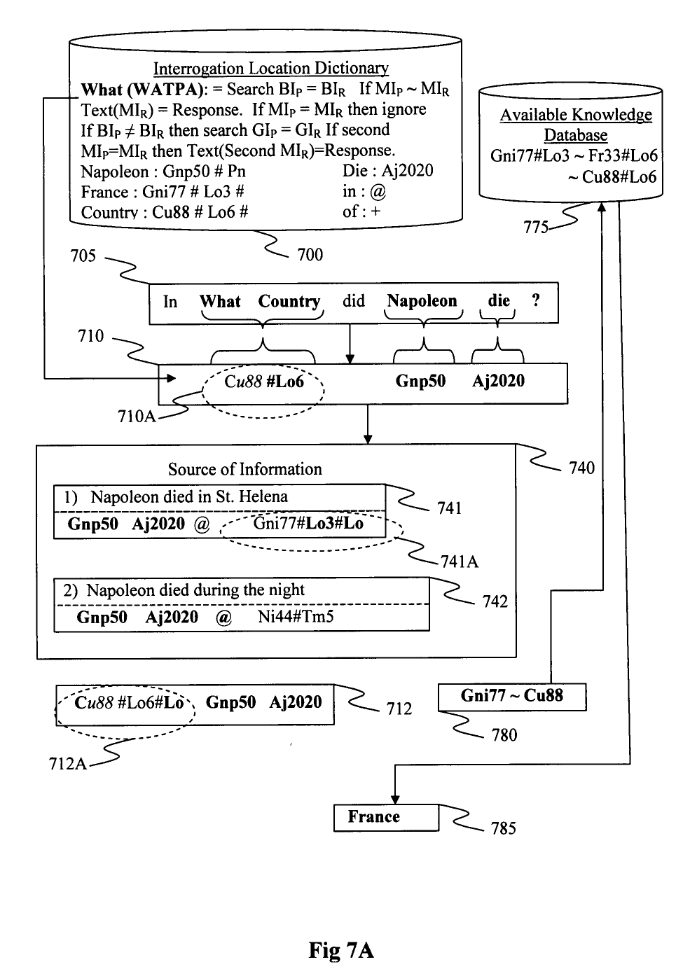

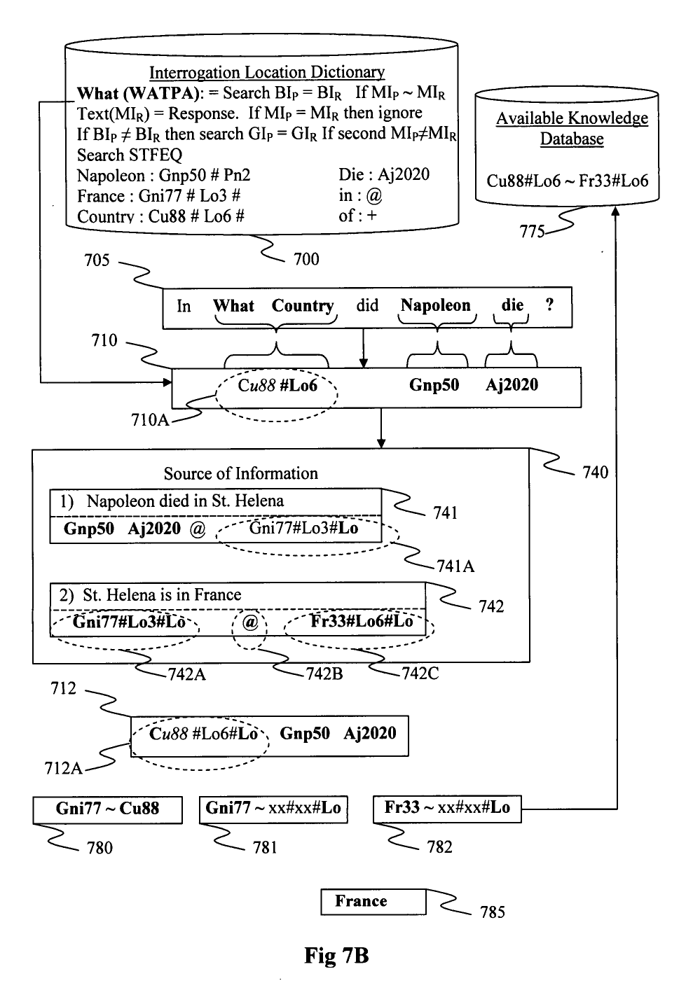

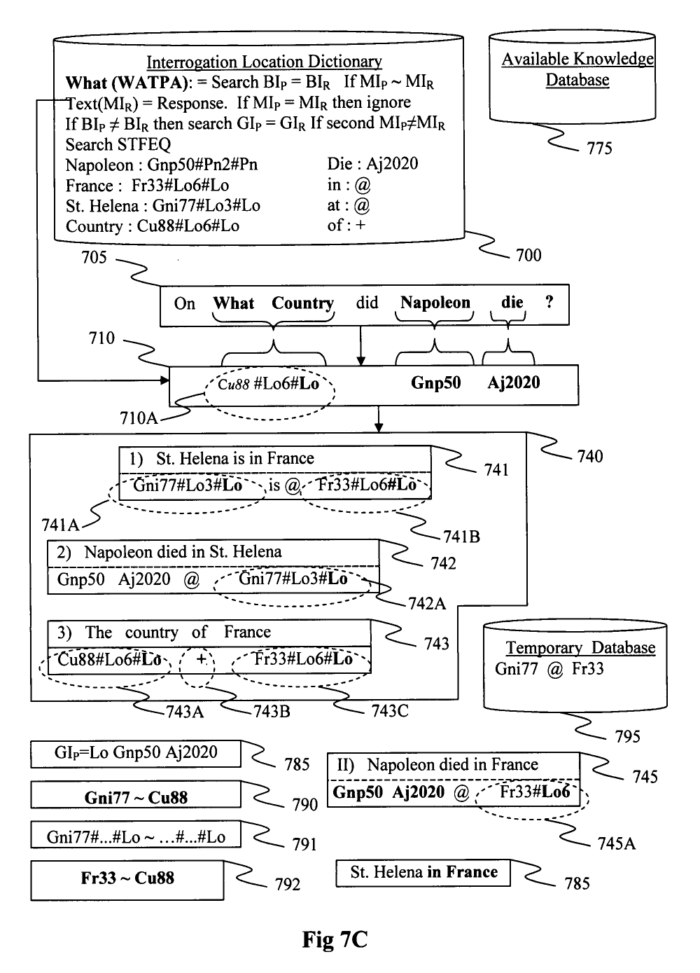

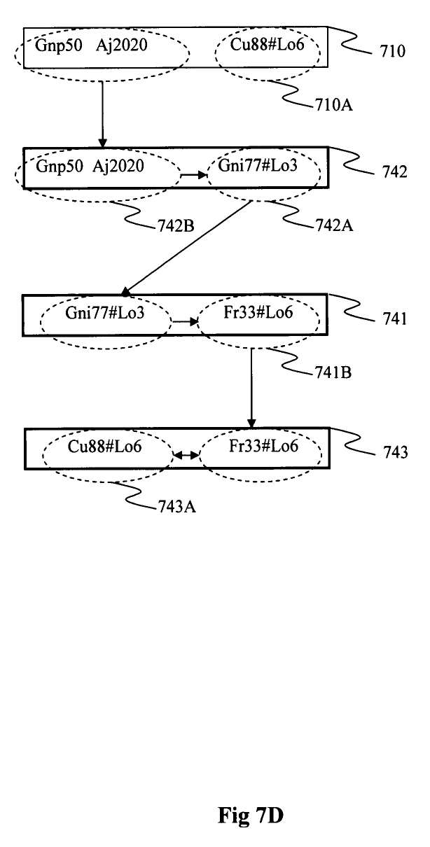

FIG. 7A, FIG. 7B, FIG. 7C, and FIG. 7D are non-limiting exemplary illustrations of other variations of the inventive method for responding to the “what” IE in spatial relationship to a noun, while implementing several additional formulation queries for discovering information that is not directly mentioned to respond to interrogations in addition to incorporating assumptions. Specifically in English, “what” and “which” are practically identical. For example, “what hour” and “which hour” are the same, and “what island” and “which island” are identical. Basically, it is just a cultural difference to decide which interrogation element is to be implemented. Consequentially, the “what” formulation (WATPA) is equal to the WITPA of “which.” Accordingly, FIGS. 7A, 7B, 7C and 7D use the same formulation. However, FIG. 7A, FIG. 7B, and FIG. 7C incorporate additional scenarios and formulation data specifically designed for finding information that is not directly disclosed. Furthermore, as a result from said affirmative discoveries, the discovery engine is able to increase and/or update its own “Memory Banks” (Available Knowledge Bases) thus incorporating a self-learning process (including general and/or new specialized dictionaries) for faster, more accurate and superior responding to interrogations. FIG. 7A illustrates an exemplary variation on the inventive method discovering additional information through an additional internal query (FEQG). Accordingly, the IQ 705 (FIG. 7A) is converted implementing the Interrogation Location Dictionary 700 (FIG. 7A) and the WATPA into the FEQB 710 (FIG. 7A). As illustrated, the WATPA incorporates additional formulation data such as “If search for BI_{P}=BI_{R} (FEQB) fails (BI_{P}≠BI_{R}), then search for GI_{P}=GI_{R} (FEQG) to discover new associations.” As illustrated by the previous FIG. 1, the “GI” information in these examples is the Third field or corpus of information of the eeggi (MI#BI#GI#AI). According, FEQB 710 (FIG. 7A) is launched searching for BI_{P}=BI_{R}. The SOI 740 (FIG. 7A) has two records; wherein the First Record 741 (FIG. 7A) fails to match (Gnp50, Aj2020 and BI_{R}=Lo3 instead of BI_{P}=Lo6), and the Second Record 742 (FIG. 7A) also fails to provide sufficient matches. According to the new WATPA information (if the FEQB fails, then try the FEQG) the FEQG 712 (FIG. 7A) or “GI=Lo Gnp50 Aj2020” is generated (GI_{P}=GI_{R}) and searches the SOI. This second time, the First Record 741 (FIG. 7A) has all matches, specifically the St. Helena eeggi 741A (FIG. 7A). Basically, the FEQG accomplished finding a general place of death (St. Helena) for Napoleon. Next, the Second FEQM 780 (FIG. 7A) is launched (while the First FEQM searches for MI relationships resulting from a positive FEQB; the Second FEQM searches for MI relationships resulting from GEQG). Accordingly, the Second FEQM (Gni77˜Cu88) finds a relationship in the Available Knowledge Database 775 (FIG. 7A), but through the FR33 eeggi. Consequentially, the response at least implements the eeggi relating Cu88 (Fr33), thus responding “France” as illustrated by the Response Display 785 (FIG. 7A). FIG. 7B illustrates a non-limiting exemplary illustration of the inventive method discovering concealed information through several new formulation queries (NFEQ). In addition, the discovery engine has the option to register said “new relations” in a temporary knowledge database, which can later be registered in permanent Knowledge Databases thus incorporating a self-teaching or learning process. For example, the IQ 705 (FIG. 7B) is converted implementing the WATPA and the Interrogation Location Dictionary 700 (FIG. 7B) into the FEQB 710 (FIG. 7B) or “BI_{P}=BI_{R}” to search the SOI 740 (FIG. 7B). As illustrated the SOI has two records; wherein the First Record 741 (FIG. 7B) fails to offer a match (Gnp50, Aj2020 and BI_{R}=Lo3 instead of BI_{P}=Lo6), the Second Record 742 (FIG. 7B) also fails to satisfy all matches. Appropriately, the new rule specifies that if FEQB fails then try FEQG. Accordingly, the FEQG 712 (FIG. 7B) or “GI=Lo Gnp50 Aj2020” is launched (GI_{P}=GI_{R}). This time, the First Record 741 (FIG. 7B) has all matches, specifically the St. Helena eeggi 741A (FIG. 7B). Therefore, in similar fashion to the method of FIG. 7A, the Second FEQM 780 (FIG. 7B) is launched (MI_{P}˜MI_{R}) intending to find a relation between Gni77 and Cu88. Unfortunately, the Second FEQM fails to find any relationship (no where are Gni77 and Cu88 related). However, the previous FEQG 712 (FIG. 7B) did return positive results. Basically, what the FEQG accomplished was to find a general place of death (St. Helena) for Napoleon; while the IQ 705 (FIG. 7B) is requesting a specific place (what country). Therefore, the next obvious step is to find an obscure relationship(s) that indirectly relates Gni77 (St. Helena) with Cu88 (country). Consequentially, several methods and queries can potentially discover the said obscure relationship such as the “Stem Formulation Eeggi Query” or STFEQ for short. The STFEQ resembles the trunk of a tree, wherein many queries can lead to no results, yet the continuation of a series of queries may finally lead to a single answer (top of the tree). Accordingly, the First STFEQ 781 (FIG. 7B) is launched. As illustrated, the First STFEQ 781 (FIG. 7B) or “Gni77 and xx#xx#Lo” intends to discover any location eeggi associated to the Gni77 eeggi (St. Helena). In such fashion, the new association may hopefully lead to Cu88, thus enabling to respond to the interrogation. Accordingly, the STFEQ 781 (FIG. 7B) searches the SOI once again, this time returning positive results such as the Second Record 742 (FIG. 7B) which successfully associates (@) Gni77 and Fr33 in such fashion that Fr33 can substitute Gni77. Consequentially, the next STFEQ 782 (FIG. 7B) or “Fr33 xx#xx #Lo” is launched intending to find a relationship between Fr33 and Cu88. Fortunately, the Available Knowledge Database 775 (FIG. 7B) provides the said relationship; therefore the text of the eeggi ultimately responsible for relating to Cu88 (France) is displayed as the answer, as illustrated by the Response Display 785 (FIG. 7B). Please note, there are many STFEQ type queries such as the “Gni77@” and “in Gni77” that further associate the “Gni77” location eeggi to even other eeggi species such as that of a museum or art piece, which ultimately may lead to Cu88 (country). FIG. 7C is another non-limiting exemplary illustration of the inventive method similar to the one depicted in FIG. 7B, but this time the Available Knowledgebase never provides any relationships, and the discovered concealed relationships are registered in temporary Databases that can later be verified and/or modified before they are registered in the Available Knowledge Database. Particularly this example depicts and/or demonstrates how the discovery engine discovers that “France” is a country and also that St. Helena is in France in order to answer the interrogation “In what country did Napoleon die.” Accordingly, the IQ 705 (FIG. 7C) is replaced and/or converted into the FEQB 710 (FIG. 7C) utilizing the Interrogation Location Dictionary 700 (FIG. 7C). Accordingly, the FEQB 710 (FIG. 7C) searches the SOI for BI_{P}=BI_{R}. As illustrated by the SOI 740 (FIG. 7C), not the First Record 741 (FIG. 7C), nor the Second Record 742 (FIG. 7C) nor the Third Record 743 (FIG. 7C) match the FEQB 710 (FIG. 7C) or “BI_{R}=Lo6, Gnp50, and Aj2020.” Consequentially, as indicated by WATPA the FEQG 785 (FIG. 7C) or “GI_{P}=Lo, Gnp50, and Aj2020” is launched trying to find records wherein “GI_{P}=GI_{R}.” As illustrated in the SOI 740 (FIG. 7C), the First Record 741 (FIG. 7C) does not match, therefore is ignored. In similar fashion, the Third Record 743 (FIG. 7C) lacks the eeggis of FEQG 785 (FIG. 7C). However, the Second Record 742 (FIG. 7C) has all matching eeggi (GI_{R}=Lo, Gnp50, and Aj2020). Accordingly, the Second FEQM 790 (FIG. 7C) is launched to find if Gni77 relates to Cu88. Unfortunately, the FEQM search fails to retrieve any results. Accordingly, the STFEQ 791 (FIG. 7C) is launched intending to find any location relationships to Gni77 (St. Helena). Please note, that while in previous exemplary methods little or no attention was paid to the type of association (as long a there was an association, that satisfied the search), in FIG. 7C the type of association is further exploited for contemplating more focused searches for precise results. As illustrated in the Interrogation Location Dictionary 700 (FIG. 7C), the eeggis of the words “in,” “at,” and “of,” have particular significance and direction when describing geographical associations. Particularly in English, the eeggi of the word “in” or “@” has the directional ability for associating eeggis from left to right. For example, the eeggi group “A1@B2” directionally associates A1 to B2; but not B2 to A1; which in words would be similar to say “California is in USA” but not “USA is in California.” In other words, California “in” USA undoubtedly associates both California and USA, but directionally and geographically speaking, it says that California is part or contained by USA and not vice versa. Accordingly, the STFEQ 791 (FIG. 7C) enforces the @eeggi after the Gni77 eeggi, which fortunately finds a result in the First Record 741 (FIG. 7C) “Gni77#Lo3#Lo 741A (FIG. 7C)@Fr33#Lo6#Lo 741B (FIG. 7C).” As a result, Gni77 can be substituted with Fr33; but not vice versa Optionally, the Gni77@Fr33 relation is registered in the Temporary Database 795 (FIG. 7C). According to this variation of the method, the Second Record 742 (FIG. 7C) is “temporarily” re-written or modified comprising of the new relational Fr33 eeggi, thus forming the Replacing Record 745 (FIG. 7C) or “Napoleon died in France.” Consequentially, an entire new interrogation can be launched this time involving the Modified Second Record 745 (FIG. 7B). In such fashion, the FEQB 792 (FIG. 7C) searches only the Modified Second Record 745 (FIG. 7C) finding that BI_{P}=BI_{R}=Lo6. Accordingly, the FEQM 792 (FIG. 7C) or “MI_{P}˜MI_{R}” finds a relationship in the Third Record 743 (FIG. 7C). Therefore the text of the eeggi 743C (FIG. 7C) is displayed as the answer illustrated by the Response Display 785 (FIG. 7C). However in this example, the Response Display 785 (FIG. 7C) also incorporates the text version of Gni77 also responsible for discovering the Cu88 relation. Furthermore, the Temporary Database 795 (FIG. 7C) and/or discovered information from the Third Record 743 (FIG. 7C) are registered in the Available Knowledge Database 775 (FIG. 7C), thus allowing the discovery engine the ability of self teaching. Noteworthy, ignoring the direction ruling of the “@” eeggi, would have allowed the system to implement other queries (now or later) associating Gni77 (St. Helena) with other location eeggis, such as that of a Boulevard or street that could possibly and ultimately have helped to associate Gni77 (St Helena) with Fr33 (France). Noteworthy, the numeric spectrum ability of eeggi(s) also permits the manipulation of the BI values (and others) to be changed or modified, thus opening the possibility of incorporating “assumption” scenarios that could ultimately lead to unsolved solutions or possibilities. For example, the BI of a proximal eeggi in the FEQ is “Lo6.” Numerically modifying its spectrum to “Lo3” (Lo6-3) creates the possibility of proceeding with other assuming type FEQs. In equal fashion the BI of the eeggi in the Sources of Information, could contemplate being modified and intend assuming results and records which could ultimately find possible answers to unresolved interrogations. Please note, additional methods incorporate searches of partial information within the eeggi internal data, such as partially dealing with the Lo portion of the Lo3, thus avoiding the need to implement the GI information by simply repeating the FEQB thus omitting the FEQG queries and others. FIG. 7D is a non-limiting exemplary illustration of the major events that occurred in most figures (FIG. 7A, FIG. 7B and FIG. 7C) while at the same time will assist or aid in the visualization of more abstract and general variations of the inventive method. Basically, the IQ 710 (FIG. 7D) required the retrieval of an eeggi associated to the Proximal eeggi “Cu88#Lo6” 710A (FIG. 7D). The “Gni77#Lo3” eeggi 742A (FIG. 7D) was found because of the other two non-questionable eeggis 742B (FIG. 7D) present in the Second Record 742 (FIG. 7D), which later lead to the discovery of the “Fr33#Lo6” eeggi 741B (FIG. 7D) in the First Record 741 (FIG. 7D), which ultimately lead to a relationship to the “Cu88#Lo6” eeggi 743A (FIG. 7D) in the Third Record 743 (FIG. 7D) thus ultimately satisfying the relationships for answering the interrogation. Noteworthy, although the examples of FIG. 7A, FIG. 7B, 7C and summarizing FIG. 7D specifically implement same species (Lo type) interrelationships, it is also possible to utilize multiple internal information (MI+BI+GI+other) to discover further relationships to respond to interrogation type queries. For example, trying to find an answer to the query “In which country did Napoleon die?” based on the following information: “Napoleon died in St. Helena,” “the Leru museum is in St. Helena,” “the Papou painting is in the Leru Museum,” and “the Papou painting is in France.” Please note, how the “in” relationship was bolded, in an effort to identify the further importance of the type of relation found or made available to deduct a response to an interrogation, leading to the possibility of knowledge databases capable of associating and/or relating several types of BI, MI and further eeggi elements. Furthermore, FIG. 7D leads to the possibility of enabling or assuming relationships that are not present or are absent in present SOIs, thus leading to possible solutions that could later be re-interrogated to prove if the said assumption(s) were indeed correct; which will ultimately lead to register said assumptions as real relationships in the Available Knowledge Databases.

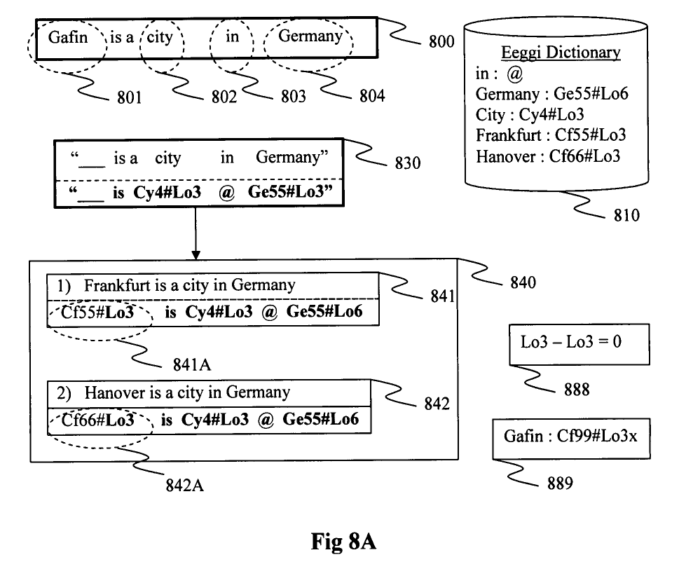

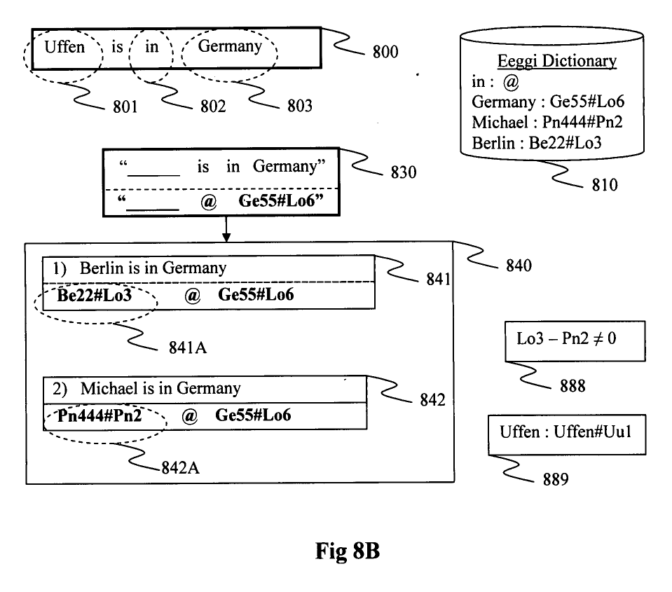

FIG. 8A and FIG. 8B are non-limiting illustration of another variation of the inventive method for identifying and/or becoming suspicious of an unknown or questionable species (BI) of a new or current word and its eeggi. Optionally, allowing to register said eeggi and/or creating a temporary new eeggi that can later be analyzed and/or approved, by permitting at least one of a: exterior input confirming the eeggi internal information (MI, BI, etc.), self generating a series of external and/or internal queries involving the new discovered word or eeggi, and implement time and usage to verify the assumed eeggi information among others. For example, the Target Sentence 800 (FIG. 8A) is translated or compared with the Eeggi Dictionary 810 (FIG. 8A). As illustrated, the Unidentified Word 801 (FIG. 8A) or “Gafin” has no corresponding eeggi in the Eeggi Dictionary. Consequentially, a series of internal queries are launched implementing at least one proximal eeggi such as the First Known eeggi 802 (FIG. 8A) or “city,” the Second Known eeggi 803 (FIG. 8A) or “in,” and the Third Known eeggi 804 (FIG. 8A) or “Germany.” Accordingly, the new eeggi Internal Information Query 830 (FIG. 8B) or EIIQ for short, containing all the known eeggis (First, Second and Third) of the Target Sentence searches other sentences or information to help identify the BI (or other information) of the new word/eeggi (Gafin). In this particular example, the EIIQ 830 (FIG. 8A) is a string type query enforcing direction or implementing quotes (“ ”) thus searching for the exact position of words or eeggis as depicted by the Target Sentence 800 (FIG. 8A) except for “Gafin” or its unknown corresponding eeggi. Please note that other technologies do not require said quotes or string search for taking into consideration the conceptual directionality, such as that of compound eeggis. Returning to FIG. 8A, the search is executed upon the SOI 840 (FIG. 8A) which contains two matching records. The First Matching Record 841 (FIG. 8A) contains the First Comparing eeggi 841A (FIG. 8A) or “Frankfurt” which also like “Gafin” is on the left side of the known string of eeggis (is a city in Germany). Please notice the BI of “Frankfurt” or “Lo3.” In similar fashion, the Second Record 842 (FIG. 8A) matches the known string of eeggis (is a city in Germany), thus providing a second clue or Second Comparing eeggi 842A (FIG. 8A) which also contains a BI=Lo3. Please note, there are several methods for performing comparing action(s) (comparison queries) for identifying that the BI of the First Comparing eeggi 841A (FIG. 8A) or “Lo3” is identical to the BI of the Second Comparing eeggi 842A (FIG. 8A) which is also “Lo3.” In this example, the BI from both Comparing eeggis is subtracted. If the result is zero, then they are identical. Accordingly, the Subtraction Calculation 888 (FIG. 8A) results in zero, therefore a Temporary eeggi 889 (FIG. 8A) is formed for the word “Gafin” comprising a BI of “Lo” and/or “Lo3x” (the x flags the eeggi to be verified in the future). Optionally, posterior modifications can be, implemented, identifying the exact BI corresponding to the eeggi of Gafin.” In FIG. 8B, a different scenario is illustrated, this time involving several results or records comprising different BI or class. For example, the Target Sentence 800 (FIG. 8B) is translated or compared with the Eeggi Dictionary 810 (FIG. 8B). As illustrated, the Unidentified Word 801 (FIG. 8B) has no corresponding eeggi in the Eeggi Dictionary. Consequentially, at least one of a series of internal queries will be launched comprising the known eeggis of the Target Sentence 800 (FIG. 8B), such as the First Known eeggi 802 (FIG. 8B) or “in,” and the Second Known eeggi 803 (FIG. 8B) or “Germany” thus forming the EIIQ 830 (FIG. 8B) with the intent of finding other similar known sentences or eeggis to help identify the BI (or other information) of the new word/eeggi “Uffen” 801 (FIG. 8B). In this particular example, the EIIQ 830 (FIG. 8B) also enforces direction by implementing quotes (“ ”) or a string search, thus searching for the exact position of words or eeggis as depicted by the Target Sentence 800 (FIG. 8B). Accordingly, the search is executed upon the SOI 840 (FIG. 8B) which contains only two, but yet matching records. The First Matching Record 841 (FIG. 8B) contains the First Comparing eeggi 841A (FIG. 8B) or “Berlin” which is also on the right side (similar to Uffen) and involves the BI of “Lo3.” However, the Second Record 842 (FIG. 8B) provides the second clue or Second Comparing eeggi 842A (FIG. 8B) this time involving a “BI=Pn2.” Please note, there are several methods to perform the comparing action of identifying that the BI of the First Comparing eeggi 841A (FIG. 8B) or “Lo3” is in fact different than the BI of the Second Comparing eeggi 842A (FIG. 8B) or “Pn2.” In this example, the BI of both Comparing eeggis is subtracted. If the result is zero, then they are identical; but if the result differs from zero, then they are different. Accordingly, the Subtraction Calculation 888 (FIG. 8B) results in a value different than zero, therefore a Temporary eeggi 889 (FIG. 8B) for the word “Uffen” is formed comprising a temporary and/or unknown BI (Uu1), thus permitting its effective identification (unknown BI) for future edits, queries and/or modifications, by human, machine, and/or new records, etc.

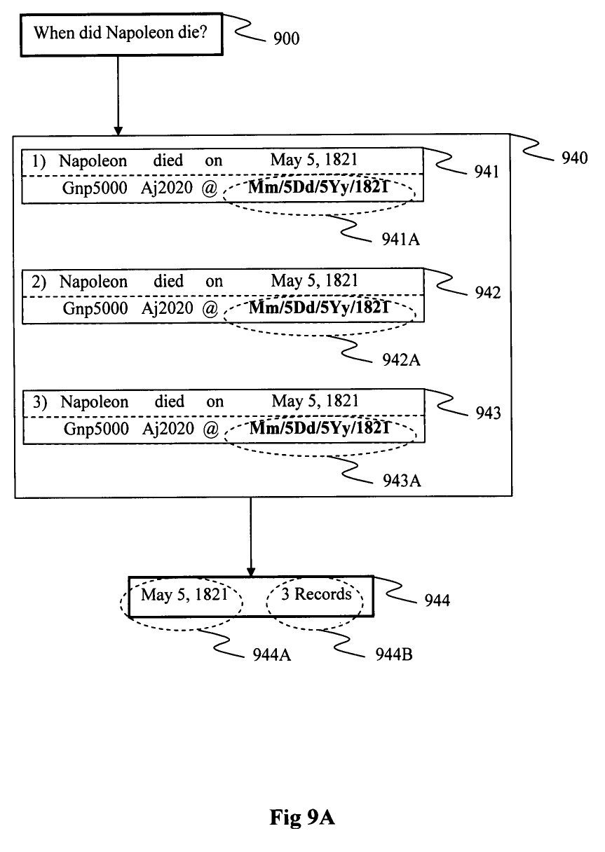

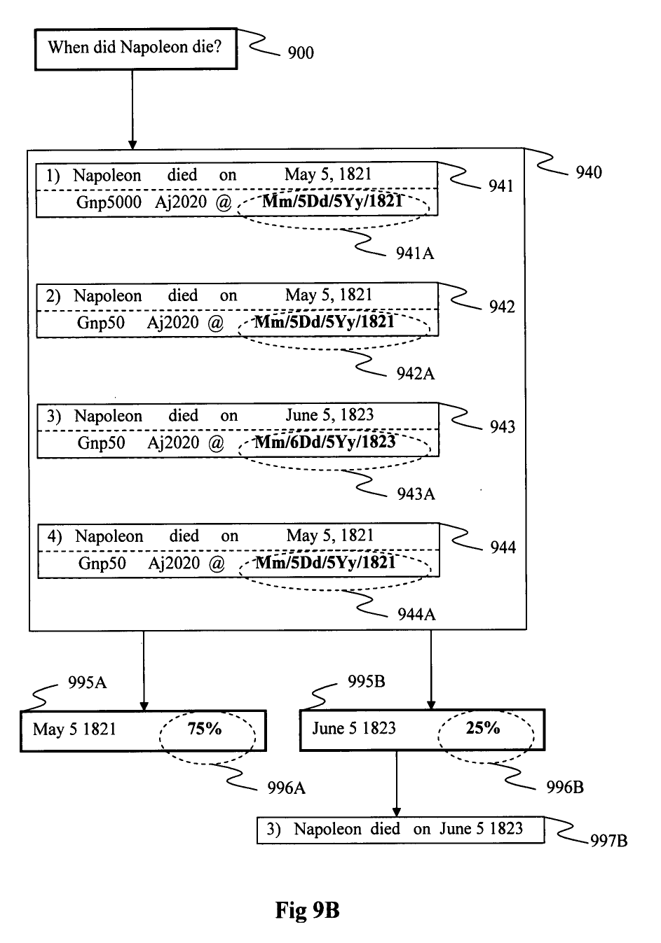

FIG. 9A and FIG. 9B are non-limiting exemplary illustrations of a further variation of the inventive method responding to an interrogation while compiling several equal responses into a single cluster response, and compiling several different responses into several cluster responses respectively; optionally utilizing statistical analysis and/or classification to identify said clusters of responses. In FIG. 9A, the SOI 940 (FIG. 9A) contains three different websites or Records all identifying and/or describing the same date of death (May 5, 1821) for Emperor Napoleon Bonaparte. For example, the First Record 941 (FIG. 9A) describes or comprises the date or eeggi “Mn/5Dd/5Yy/1821” 941A (FIG. 9A). The Second Record 942 (FIG. 9) also contains the date eeggi “Mn/5Dd/5Yy/1821” 942A (FIG. 9A). In similar fashion, the Third Record 943 (FIG. 9A) displays the same date (May 5, 1821) or eeggi “Mn/5Dd/5Yy/1821” 943A (FIG. 9A). Accordingly, when the IQ 900 (FIG. 9A) is requested, and the corresponding answer is generated/found, a comparison query is executed identifying the equality and/or similarity of all the records (First Record, Second Record, and Third Record). Accordingly, a Single Cluster Response 994 (FIG. 9A) displays the response “May 5, 1821” 994A (FIG. 9A), while also identifies the number of records 994B (FIG. 9A) responsible for generating said response/answer. On the other hand, FIG. 9B contemplates and/or illustrates the search, retrieval, and discovery of several records comprising different responses. As illustrated, the SOI 940 (FIG. 9B) contains four websites or records describing (matching the query) the date of death of Napoleon. However, not all records agree with the date of death. For example, the First Record 941 (FIG. 9B) displays the first date or Mn/5Dd/5Yy/1821 eeggi 941A (FIG. 9B). The Second Record 942 (FIG. 9B) displays the same Mn/5Dd/5Yy/1821 eeggi 942A (FIG. 9B). And equally, the Fourth Record 944 (FIG. 9) displays the same identical eeggi Mn/5Dd/5Yy/1821 944A (FIG. 9B) or date (May 5, 1821). However, the Third Record 943 (FIG. 9B) displays a different date of death (Jun. 5, 1823) or eeggi Mn/6Dd5/Yy/1823 943A (FIG. 9B). Therefore, after responding to the IQ 900 (FIG. 9B), a comparison query (or several formatting queries) identifies all equally valued eeggis distilling and separating all matching eeggis (clusters); which in the case of this example involves two different clusters of answers or responses, such as the First Response Cluster 995A (FIG. 9B) or “May 5, 1821” and the Second Response Cluster 995B (FIG. 9B) or “Jun. 5, 1823;” wherein each response cluster compiles all identical answers or records. In addition, each response display its respective statistical result, such as the First Statistical Ratio 996A (FIG. 9B) or “75%,” and the Second Statistical Ratio 996B (FIG. 9B) or “25%.” each identifying the corresponding percentage that each answer represents based on the total number of answers. Furthermore, the option of clicking on given response and/or Statistical Ratio (or other), would produce its respective Cluster Display containing or displaying all the records in the cluster responsible for generating the selected answer, such as the Second Cluster Display 997B (FIG. 9B) which displays the cluster of records accountable for generating the respective 25% percentage 996B (FIG. 9B) or ratio. Please note, index tables and others can also be implemented in conjunction or separately for performing the statistical analysis needed for producing and/or identifying the respective percentages, quantities, etc.

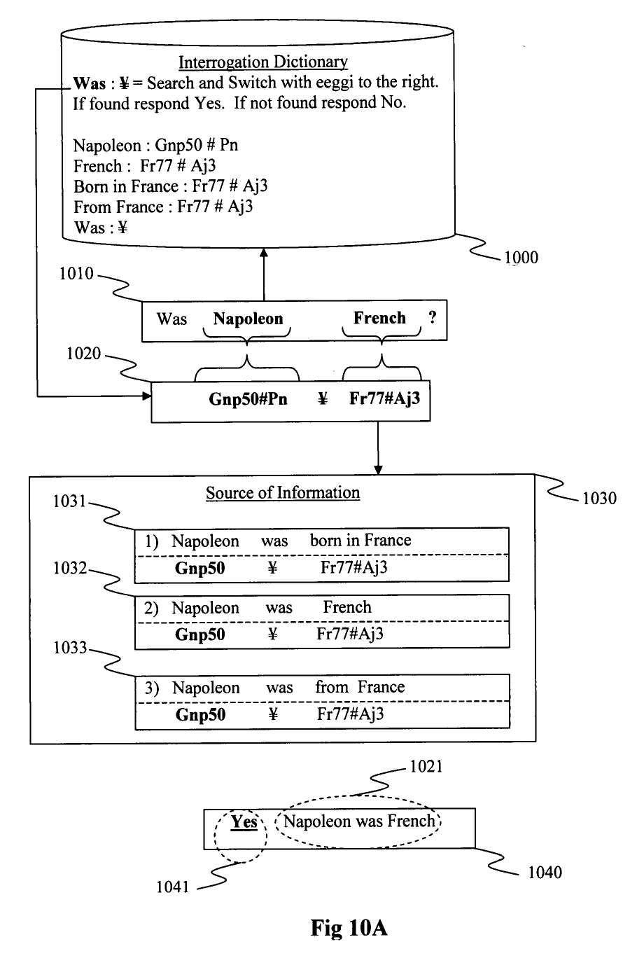

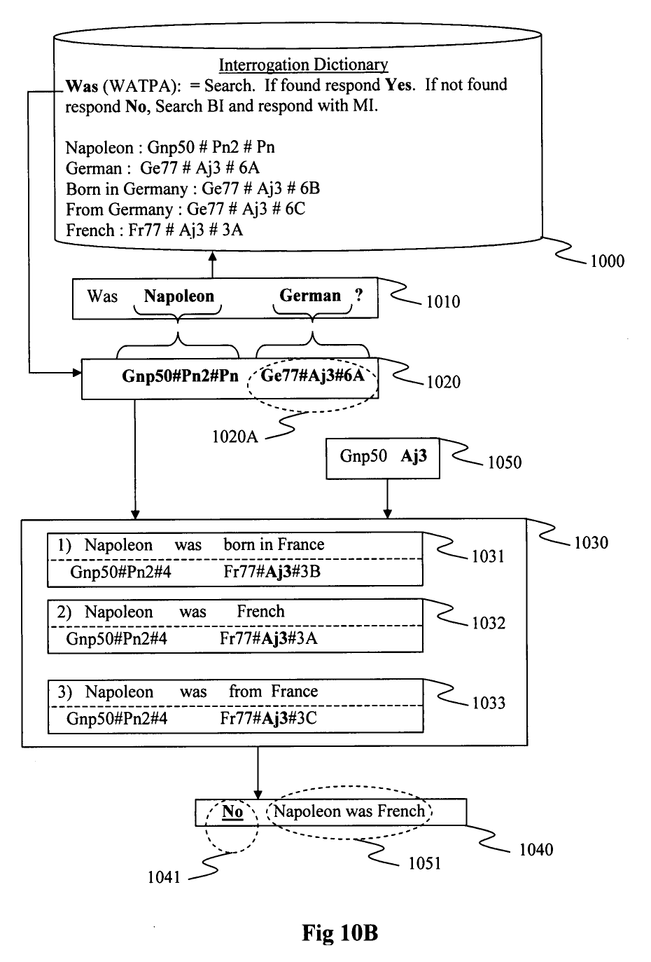

FIG. 10A and FIG. 10B are non-limiting exemplary illustrations of a further variation of the inventive method answering to affirmative and negative interrogations, such as “Did Napoleon die in France” or “Was Napoleon French?” Specifically in the English language, the grammatical interrogation elements “is, did, was, does,” and others identify a need for responding with an affirmative or negative type of answer. Basically, in this variation of the method, the existence of any of the said elements present at the beginning of an interrogational query (or active answering function) implies a “Yes” or “No” response. In FIG. 10A, the Interrogation Dictionary depicts the “was” formulation (WSFEQ): if the word “was” is first in an interrogation query, switch “was” with the right proximal word/eeggi (the word or eeggi on the right) and if search is affirmative (finds results) then answer “Yes,” and if the search is negative (finds no results) then answer “No.” Accordingly, implementing the Interrogation Dictionary 1000 (FIG. 10A) the IQ 1010 (FIG. 10A) or “Was Napoleon French?” is converted into the “Was Formulation Eeggi Query” 1020 (FIG. 10A) or WAFEQ for short containing the eeggis: Gnp50#Pn, ¥, and Fr77#Aj3. As illustrated, the SOI 1030 (FIG. 10A) contains three records such as the First Record 1031 (FIG. 10A), the Second Record 1032 (FIG. 10A), and the Third Record 1033 (FIG. 10A) all comprising the same eeggis as the WAFEQ 1020 (FIG. 10A). Accordingly, the Response Display 1040 (FIG. 10A) displays the Affirmative Response 1041 (FIG. 10A) and the Text Version 1021 (FIG. 10A) of the WAFEQ. FIG. 10B illustrates a slight variation of the method depicted in FIG. 10A this time responding to negative answer while optionally responding with what would have being an affirmative answer (answers “No” but finds a suggestive “Yes”). The Interrogation Dictionary 1000 (FIG. 10B) modifies or converts the IQ 1010 (FIG. 10B) into the WAFEQ 1020 (FIG. 10B). Please note how in this example, the word “was” has no eeggi except for the fact that it is used to identify or aid identifying an interrogation. In addition, the formulation is different to that in FIG. 10A, not only indicating how to respond, but also what to do in the event that a negative answer is generated. Accordingly, the search is executed implementing the WAFEQ 1020 (FIG. 10B) upon the SOI 1030 (FIG. 10B), which as illustrated, contains a total of only three records such as the First Record 1031 (FIG. 10B), the Second Record 1032 (FIG. 10B), and the Third Record 1033 (FIG. 10B); wherein none of the said records contains sufficient eeggi matches. Accordingly, the Negative Response 1041 (FIG. 10B) is generated or displayed in the Response Display 1040 (FIG. 10B). In addition, the optional “Corrective Individual BI Query” 1050 (FIG. 10B) or CIBQ for short, is generated implementing the BI (category information) of the “No Matching eeggi” 1020A (FIG. 10B) and the other matching eeggis; wherein the “No Matching eeggi” is the eeggi present in the WAFEQ 1020 (FIG. 10B) that was responsible for never generating a match (the eeggi that never matched). Accordingly the CIBQ 1050 (FIG. 10B) or “Gnp50 and Aj3” (Aj3 is the No Matching eeggi) searches the SOI 1030 (FIG. 10B) once more, finding in fact that all records match or have the BI=Aj3. Correspondingly, a correct response can be generated involving the text versions of all the found eeggis (Fr77#Aj3#3A, Fr77#Aj3#3B Fr77#Aj3#3C) which would be significantly valuable. In addition, other queries and methods can analyze the similarity between the found eeggis, thus leading to the ability of selecting and/or implementing at least one (most common, first found, alphabetically, etc.) eeggi/word to be displayed as illustrated in the “Correct Response” 1051 (FIG. 10B) of the Response Display 1040 (FIG. 10B).

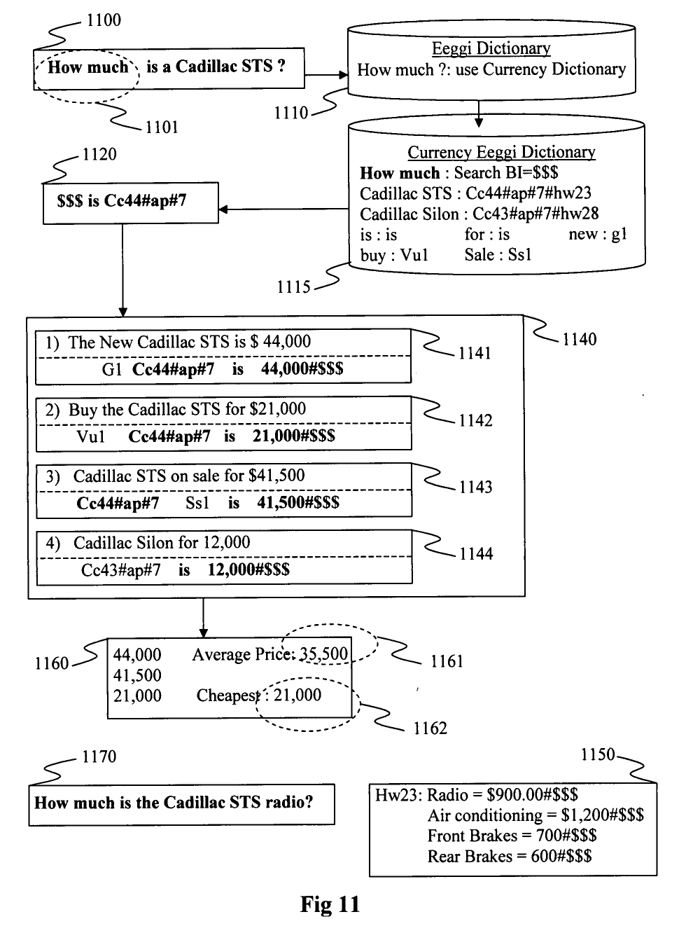

FIG. 11 is a non-limiting exemplary illustration of the inventive method dealing with a “how much” interrogation. In comparable but not identical fashion to the “when,” “where,” and “who” interrogations, the “how much” interrogation focuses the search on the BI or the “currency” eeggi, but because of the possible large variety of prices, the current and/or additional formulations take special attention to averages, maximums and minimums (limits) found or retrieved. However, in contrast to inventory eeggis, that are capable of handling the most demanding and specific queries, the eeggis of the priced elements in the example only handle or cover basic information, but through their AI (Associative Identifying Information) provide access to further more detailing information including that of the inventory eeggis themselves. For example, the IQ 1100 (FIG. 11) comprising the “How Much” interrogation element 1101 (FIG. 11) is searched in the Eeggi Dictionary 1110 (FIG. 11) which refers to the Currency Eeggi Dictionary 1115 (FIG. 11), thus converting the IQ into the Currency Formulation Eeggi Query 1120 (FIG. 11) or CUFEQ for short, implementing the said Currency Eeggi Dictionary. As illustrated, the SOI 1140 (FIG. 11) has four records or websites such as the First Record 1141 (FIG. 11), the Second Record 1142 (FIG. 11), the Third Record 1143 (FIG. 11), and the Fourth Record 1144 (FIG. 11); wherein only the Fourth Record does not have sufficient matches (eeggis). Therefore, in similar fashion to the “where” interrogation query, the text version (monetary amount) of each MI of every eeggi is utilized to respond to the interrogation. Consequentially, the values or responses vary in price ($44000, $21000 and $41500), or the MI of each “$$$” (BI) differs from one another. Accordingly, while the engine can cluster those results with equal amounts (costs), the additional step(s) of calculating the average price (average MI), Maximum price (highest MI), Minimum Price (lowest MI), etc. can be implemented for currency eeggis, thus giving the end user superior results and data understanding. For example, the Results Currency Display 1160 (FIG. 11) illustrates the prices of the “Cadillac STS” in sorting order, while displaying the Average Price 1161 (FIG. 11), and the Cheapest Price 1162 (FIG. 11). Furthermore, FIG. 11 also discloses the advantages of implementing an AI (hw23) that identifies further information not directly contained by the eeggi itself. In such fashion, a query interrogating the price of a part of the apparatus (Cadillac STS) can be retrieved and displayed still relating the said part with the car. For example, a Part Interrogation Query 1170 (FIG. 11) such as “How much is the radio of the Cadillac STS” can utilize the AI (Hw23) of the eeggi similar to an index, to identify the STS Price File 1150 (FIG. 11) for responding “$900.00” per se. Accordingly, the previous figures could have used only one information such as the MI, which ultimately was also used to identify its Associated File (similar to the Price File) containing all the remaining information of the eeggi such as the BI, etc.

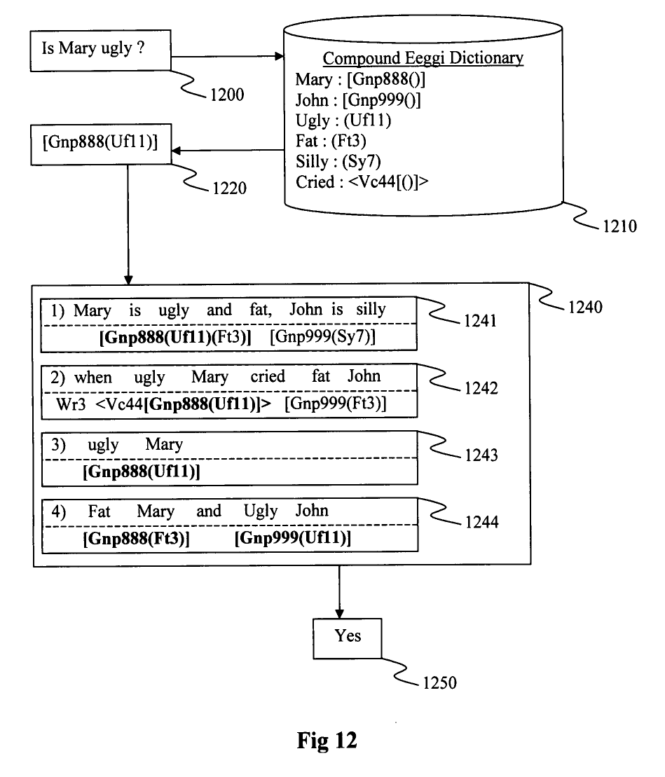

FIG. 12 is a non-limiting exemplary illustration of another variation of the inventive method dealing with compound eeggis and affirmative/negative type interrogations. While most of the disclosed methods depicted in the previous figures had to put special attention to the position of the word/eeggi in the phrase or group, compound eeggis have the ability of arranging and respecting each of the eeggis objective, array and association regardless of the style of language and content. For example, while in the previous examples the eeggis were independently position, in compound eeggis the information is arranged based of each element's objective or purpose such as adhering or incorporating the adjectives to the nouns, the adverbs to the verbs, etc. Accordingly, the IQ 1200 (FIG. 12) is converted into the Compound Eeggi Query 1220 (FIG. 12) implementing the Compound Eeggi Dictionary 1210 (FIG. 12). As illustrated in the Compound Eeggi Dictionary, the personal noun “Mary” has an eeggi comprising the exterior brackets “[ ]” and other interior brackets “( )” for incorporating other eeggis such as that of adjectives which use the “( )” as outer brackets (similar to a puzzle). In such fashion, the phrases “Mary is ugly,” “ugly Mary,” “Mary the ugly,” “as ugly as Mary,” and “ugly as Mary” are literally identified by the same compound eeggi or “[Gnp888(Uf11)}.” Accordingly, the Compound Eeggi Query 1220 (FIG. 12) searches the Source of Information (SOI) 1240 (FIG. 12) comprising a total of four records such as the First Record 1241 (FIG. 12), the Second Record 1242 (FIG. 12), the Third Record 1243 (FIG. 12), and the Fourth Record 1244 (FIG. 12). As illustrated, all records contain the words “Mary” and “ugly.” However, only the First Record, Second Record, and Third Record match or have the compound eeggi of the Compound Eeggi Query 1220 (FIG. 12). Please note, in the Fourth Record 1244 (FIG. 12) correct response can be generated involving the text versions of all the found eeggis (Fr77#Aj3#3A, Fr77#Aj3#3B Fr77#Aj3#3C) which would be significantly valuable. In addition, other queries and methods can analyze the similarity between the found eeggis, thus leading to the ability of selecting and/or implementing at least one (most common, first found, alphabetically, etc.) eeggi/word to be displayed as illustrated in the “Correct Response” 1051 (FIG. 10B) of the Response Display 1040 (FIG. 10B).

FIG. 11 is a non-limiting exemplary illustration of the inventive method dealing with a “how much” interrogation. In comparable but not identical fashion to the “when,” “where,” and “who” interrogations, the “how much” interrogation focuses the search on the BI or the “currency” eeggi, but because of the possible large variety of prices, the current and/or additional formulations take special attention to averages, maximums and minimums (limits) found or retrieved. However, in contrast to inventory eeggis, that are capable of handling the most demanding and specific queries, the eeggis of the priced elements in the example only handle or cover basic information, but through their AI (Associative Identifying Information) provide access to further more detailing information including that of the inventory eeggis themselves. For example, the IQ 1100 (FIG. 11) comprising the “How Much” interrogation element 1101 (FIG. 11) is searched in the Eeggi Dictionary 1110 (FIG. 11) which refers to the Currency Eeggi Dictionary 1115 (FIG. 11), thus converting the IQ into the Currency Formulation Eeggi Query 1120 (FIG. 11) or CUFEQ for short, implementing the said Currency Eeggi Dictionary. As illustrated, the SOI 1140 (FIG. 11) has four records or websites such as the First Record 1141 (FIG. 11), the Second Record 1142 (FIG. 11), the Third Record 1143 (FIG. 11), and the Fourth Record 1144 (FIG. 11); wherein only the Fourth Record does not have sufficient matches (eeggis). Therefore, in similar fashion to the “where” interrogation query, the text version (monetary amount) of each MI of every eeggi is utilized to respond to the interrogation. Consequentially, the values or responses vary in price ($44000, $21000 and $41500), or the MI of each “$$$” (BI) differs from one another. Accordingly, while the engine can cluster those results with equal amounts (costs), the additional step(s) of calculating the average price (average MI), Maximum price (highest MI), Minimum Price (lowest MI), etc. can be implemented for currency eeggis, thus giving the end user superior results and data understanding. For example, the Results Currency Display 1160 (FIG. 11) illustrates the prices of the “Cadillac STS” in sorting order, while displaying the Average Price 1161 (FIG. 11), and the Cheapest “ugly” was incorporated by “John” and not by “Mary” thus leading to different (not matching) compound eeggis. Accordingly, the Response 1250 (FIG. 12) is displayed affirming that “Mary is ugly.”

Noteworthy, further identification of the types of eeggis in an interrogation query and their respective combinations can lead to methodologies to recognize interrogations with no sense. For example, an interrogation such as “Napoleon was General” does not format a proper interrogation, thus enabling the possibility for the discovery engine to request and/or modify the interrogation query by itself and/or with the assistance of the inquirer, such as displaying “sorry, can not understand your question” and further provide some possible suggestions. Another example is that of “Was Napoleon a Cadillac STS?” wherein the eeggi elements contradict each other or form unlikely query formats.

Noteworthy, although the present disclosure focused on a few types of information such as “locations, nouns, currency and times, there are many other types of information the disclosed inventive method appropriately handles without departing from the main spirit and scope of the idea.

Noteworthy, the numerals implemented to identify the elements and drawings on the present disclosure of the inventive method, do not interrelate with previous figures, although they many times resemble each other.

Noteworthy, although the present disclosure contemplates the English Language in particular, other languages and dialects would incur and imply different formulations, eeggis, respective types and associations without departing from the main scope and spirit of the idea.

Noteworthy, other methodologies such as that of implementing the internal information of the other eeggis not directly involved in the disclosed formulation, leads to other formulations such as that required for responding to “In what country did Napoleon die” when the Record in the Source of Information discloses “Napoleon was poisoned in St. Helena”

Noteworthy other new and current interrogation elements can incorporate the main spirit and scope of the disclosed inventive method such as “Whi” which could refer to a male animal in similar fashion that “who” refers to a human or “Whu” which could refer to a “sale item” in similar fashion that “where” refers to a location.

Noteworthy, several search and retrieval methodologies and technologies such as “Text,” and “Group Identifier” can further make use of the disclosed inventive method in partial or whole without departing from the main scope and spirit of the idea.

Noteworthy, additional and optional methodologies and technologies such as speech recognition, and speech volume emphasis can further enhance and abilities of the methodologies of the disclosed inventive method.

Noteworthy, entry queries can be originated from any type of information seeking entity such as a human, program, and/or machine. In similar manner, the ensuing results can be provided to either of those entities.

Noteworthy, additional search programs or portfolios can assists a user in finding what they inquire. For example, while in a hospital a newborn's full name is registered, it is then possible to for a discovery engine using search portfolios to respond to an interrogation such as: “Is Frank J. Williams an American,” or “What is Frank's father's name.”

Noteworthy, other interrogation elements, like “how long ago” and “why” can implement various variations of the disclosed inventive method including current and variable Databases or Sources of Information, such as that need to answer to “how long ago did Napoleon die?, thus allowing the discovery engine to answer “183 years 6 month and 22 days ago” (today's date—date of death).

Noteworthy, relational elements such as: is, in, at, of and others can assume different formulations, values and/or attributes depending on the Databases, Dictionaries and/or other formulations being implemented.

Noteworthy, the ranges and/or quantities of information identifying a word (text, group identifiers, eeggis, etc) identifiable for performing responses may vary according to the languages, comas, semicolons, other grammatical elements, and particular number of existing words or others (eeggi, group identifiers, etc.) in the corpus of information.

The enablement's/embodiments described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a series of novel methods for searching, discovering, retrieving and responding to interrogations can be appreciated. The described methods overcome the conceptual limitations encountered when interrogating for information. Furthermore, the methodologies teach several methods for retrieving concealed and or deductive information thus incorporating what is here introduced as Relational Intelligence.”

1. A method for responding to an interrogation, the method comprising the steps of:
a) Identifying a first information requesting a location, such as where;
b) Identifying a second information identifying a location;
c) Finding said second information;
d) Displaying at least one of a: said second information, and information identifying said second information.

2. A method for responding to an interrogation, the method comprising the steps of:
a) Identifying a first information requesting a category of information, such as where, when, and who;
b) Identifying a second information identifying a said category of information;
c) Finding said second information;
d) Displaying at least one of a: said second information, and information identifying said second information.
